(19) United States
(12) Patent Application Publication
(10) Pub. No.: US 2024/0278275 A1
(43) Pub. Date: Aug. 22, 2024

(54) NON-CONTACT ULTRASONIC NOZZLE CLEANER WITH CLOSED-LOOP AUTOMATIC CLOG DETECTION

(71) Applicant: NORDSON CORPORATION, WESTLAKE, OH (US)

(72) Inventors: Michael SZUCH, Carlsbad, CA (US); Timothy GIRVIN, San Diego, CA (US); Alan LEWIS, Carlsbad, CA (US); Alon DAGAN, San Diego, CA (US)

(73) Assignee: NORDSON CORPORATION, WESTLAKE, OH (US)

(21) Appl. No.: 18/569,480

(22) PCT Filed: Jun. 24, 2022
(86) PCT No.: PCT/US2022/034850

§ 371 Date: Dec. 12, 2023

Related U.S. Application Data
(60) Provisional application No. 63/214,386, filed on Jun. 24, 2021.

(51) Int. Cl. B05B 12/08; B05B 15/52; B05B 15/55

(52) U.S. Cl. CPC B05B 12/085; B05B 15/52; B05B 15/55

(57) ABSTRACT

Systems and methods of operating and cleaning coating systems are disclosed. A method of applying a material to a substrate includes dispensing the material onto a substrate using an applicator, the applicator being configured to receive the material therein and to discharge the material therefrom toward the substrate; measuring a parameter of the material being dispensed via the applicator; determining whether the parameter is within a predetermined range; when the parameter is not within the predetermined range, stopping the dispensing of the material onto the substrate and cleaning the applicator such that the parameter is within the predetermined range; and after cleaning the applicator, resuming dispensing the material.

### CROSS-REFERENCE TO RELATED APPLICATIONS

This application is a National Stage Application of International Patent Application No. PCT/US2022/034850, filed Jun. 24, 2022, which claims the benefit of U.S. Provisional Patent App. No. 63/214,386, filed Jun. 24, 2021, the entire disclosures of both of which are hereby incorporated by reference as if set forth in their entirety herein.

### TECHNICAL FIELD

The present invention generally relates to applying conformal coating materials and, more particularly, to mechanisms and methods of cleaning a conformal coating applicator and reducing an occurrence of clogging of the same.

### BACKGROUND

Conformal coating is typically the process of applying a dielectric material onto an electrical component, for example, a printed circuit, a printed circuit board (PCB), a device mounted thereon, and/or the like to protect it from moisture, fungus, dust, corrosion, abrasion, vibration, chemicals, tin whiskers, other environmental stresses, and/or the like. Conformal coating materials range from solvent based materials that cure by evaporation of the solvent to “100% solid” conformal coating materials. Common conformal coating materials include silicones, acrylics, urethanes, epoxy synthetic resins, various polymers, and/or the like. When applied to PCBs, an insulative resin film of uniform thickness is typically formed as a solvent evaporates or as a solvent-free material is cured.

Automated selective coating systems are known. Such systems can have conformal coating dispensers that dispense material in various patterns with varying deposition accuracies and that produce coatings with varying thicknesses. During operation, portions of the coating system can retain some of the coating material. The nozzles of the coating dispensers can accumulate coating material due to the nature of the coating material itself, due to particular application processes and patterns and/or the like. The accumulated coating material can cure, harden, or otherwise clog or interfere with continued dispensing of the coating material from the affected dispenser nozzle.

Several mechanisms for cleaning accumulated or residual coating material from nozzles exists in the field. In some scenarios, when the dispenser nozzle is not being used, the dispenser nozzle may be stored in a reservoir having a solvent that interacts with any uncured coating that has accumulated on the nozzle and prevents the uncured coating from curing and/or solidifying and clogging the nozzle. However, in some coating scenarios, the excess coating material deposited on the nozzle during operation begins to cure and form clogs during the operating process itself. Thus, while the solution of storing the nozzle in a reservoir with solvent helps decrease formation of clogs when the excess material has not yet cured, it is not as useful to prevent clogs from material that cures during operation. Typically, storing the nozzle in the solvent after the material has already cured is less effective at removing the excess material from the nozzle.

Another solution that is sometimes utilized is to mechanically clean the nozzle with a suitable tool. In such scenarios, a user can brush or wipe excess material off the nozzle. The nozzle can be configured to be moved relative to a brush to remove the excess material. However, this solution results in the brush accumulating the excess material over time and, if not adequately cleaned or replaced, depositing some of the accumulated material back onto a nozzle in a subsequent cleaning step. Additionally, some nozzles may be formed of delicate material that could be damaged by the mechanical scrubbing of the bristles of a brush.

Therefore, there is a need for an improved mechanism and/or process of cleaning excess coating material from conformal coating dispensers.

### SUMMARY

The foregoing needs are met by various aspects of coating assemblies and related methods disclosed. According to an aspect of this disclosure, a method of applying a material to a substrate includes dispensing the material onto a substrate using an applicator, the applicator being configured to receive the material therein and to discharge the material therefrom toward the substrate: measuring a parameter of the material being dispensed via the applicator; and comparing the measured parameter to a reference value. Based on the comparison, the method includes stopping the dispensing of the material onto the substrate and cleaning the applicator such that the parameter is within the predetermined range. After cleaning the applicator, the method includes the step of resuming dispensing the material.

Optionally, measuring the parameter of the material may include measuring at least one of a flow rate of the material, a temperature of the material, and a pressure of the material.

Optionally, measuring the parameter may include measuring a first parameter and measuring a second parameter, wherein the method may further include comparing the measured first parameter with the measured second parameter. Determining whether the parameter is within the predetermined range may include determining whether the second measured parameter is within a predetermined range compared to the first parameter.

Optionally, the applicator may be in an operating position when the dispensing step is performed, and the method may further include moving the applicator to a cleaning position when the parameter is not within the predetermined range.

Optionally, the step of cleaning the applicator may include contacting the applicator with a cleaning material for a predetermined duration.

Optionally, the cleaning material may include a solvent.

Optionally, the method may include actuating an ultrasonic transducer to agitate the cleaning material to form cavitation bubbles in the cleaning material.

Optionally, the method may include receiving electronic feedback from the ultrasonic transducer and adjusting operation of the ultrasonic transducer based on the received electronic feedback.

Optionally, the electronic feedback may include at least one of current feedback and phase feedback.

Optionally, adjusting operation of the ultrasonic transducer based on the received electronic feedback may include operating the ultrasonic transducer at its resonant frequency.

Optionally, the method may include measuring a fluid level of the cleaning material, comparing the measured fluid level to a predetermined value, in response to a determination that the measured fluid level is less than the predetermined value, adding cleaning material to raise the fluid level of the cleaning material to be greater than or equal to the predetermined value.

Optionally, the reference value may be a predetermined range of values defined between a lower threshold value and an upper threshold value, and the comparison may include determining if the measured parameter is within the predetermined range.

Optionally, the step of stopping the dispensing may include instructing the coating system to stop the dispensing immediately after completion of the comparison step.

Optionally, the step of stopping the dispensing may include instructing the coating system to stop dispensing after a predetermined amount of time has passed after completion of the comparison step.

According to another aspect of this disclosure, a method of predicting future formation of a clog in a coating system having a dispensing applicator is disclosed. The dispensing applicator is configured to dispense a material onto a substrate. The method includes measuring a first parameter of the material in the applicator at a first instance: identifying presence of a first clogging condition: generating an association between the first parameter and the clogging condition: measuring the first parameter of the material at a second instance after the first instance; and using the measured first parameter at the second instance and the generated association, predicting a future occurrence of a second clogging condition.

Optionally, the step of predicting the future occurrence of the second clogging condition may include using a predetermined control value for the first parameter.

Optionally, the predetermined control value may include a control range of predetermined values.

Optionally, the method may include notifying a user of the predicted future occurrence of the second clogging condition.

Optionally, the method may include activating a cleaning process prior to occurrence of the predicted second clogging condition, wherein the cleaning process includes removing an accumulated material from the applicator.

Optionally, the first parameter may include at least one of an operation parameter of the coating system and a coating material parameter, wherein the operating parameter of the coating system includes at least one of size of the dispensing applicator, an identifier of the coating material, and an identifier of the substrate, and wherein the coating material parameter includes at least one of coating material pressure, coating material flow rate, coating material temperature, duration of coating operation, elapsed time since a previous applicator cleaning, quantity of substrates being coated, and quantity of substrates coated since the previous applicator cleaning.

Optionally, the method may include forming an association between the elapsed time since the previous applicator cleaning and the first clogging condition.

Optionally, the method may include generating a plurality of associations, and wherein a future occurrence of the second clogging condition includes identifying a portion of the plurality of generated associations and utilizing a portion of the plurality of generated associations to extrapolate a predicted association between the first parameter and a future second clogging condition.

According to another aspect of this disclosure, a method of cleaning a dispensing applicator through which a material is dispensed onto a substrate includes measuring a parameter associated with the applicator when the applicator is in a dispensing position, in which the applicator is configured to dispense the material onto the substrate; when the measured parameter exceeds a predetermined threshold value, moving the applicator from the dispensing position to a cleaning position, in which the applicator is not configured to dispense the material onto the substrate; and cleaning the applicator in the cleaning position.

Optionally, measuring the parameter may include measuring the parameter at a first iteration and measuring the parameter at a second iteration, wherein the method may further include comparing the measured parameter at the first iteration with the measured parameter at the second iteration to determine whether a difference between the measured parameter at the first iteration and at the second iteration exceeds a predetermined threshold value.

Optionally, measuring the parameter may include measuring a first parameter and a second parameter.

Optionally, the first parameter may include temperature of the material, and the second parameter may include flow rate of the material.

Optionally, if the measured temperature of the material at the second iteration does not exceed the predetermined threshold value compared to the measured temperature at the first iteration, and the flow rate of the material at the second iteration is below the predetermined threshold value, the method may include moving the applicator from the dispensing position to the cleaning position and cleaning the applicator.

Optionally, the cleaning step may include contacting the applicator with a cleaning material.

Optionally, the cleaning material may include a solvent.

Optionally, the cleaning step may include activating an ultrasonic transducer to generate ultrasonic waves within the cleaning material to agitate the cleaning material such that cavitation bubbles are formed.

Optionally, the method may include receiving electronic feedback from the ultrasonic transducer and adjusting operation of the ultrasonic transducer based on the received electronic feedback.

Optionally, the electronic feedback may include at least one of current feedback and phase feedback.

Optionally, adjusting operation of the ultrasonic transducer based on the received electronic feedback may include operating the ultrasonic transducer at its resonant frequency.

Optionally, the method may include measuring the parameter after the cleaning step.

Optionally, before measuring the parameter after the cleaning step, the method may include moving the dispensing applicator to the dispensing position and dispensing the material through the dispensing applicator.

Optionally, before measuring the parameter after the cleaning step, the method may include moving the dispensing applicator to a purging position and dispensing the material through the dispensing applicator.

According to yet another aspect of this disclosure, a coating system for dispensing a material onto a substrate includes an applicator configured to receive a coating material from a coating material source, the applicator including an outlet through which the material is configured to flow out of the applicator towards the substrate: a dispensing assembly configured to cause dispensing of the material from the applicator: an applicator positioning assembly operably connected to the applicator and configured to cause the applicator to move between a dispensing position and a cleaning position; and a cleaning assembly configured to remove a residual material from the applicator. When the applicator is in the dispensing position, the applicator is not in contact with the cleaning assembly and is configured to dispense the material onto the substrate, and when the applicator is in the cleaning position, the applicator is in contact with the cleaning assembly, is not configured to dispense material, and is configured to be cleaned by the cleaning assembly.

Optionally, the coating system may include a heater configured to provide heat to the material in the applicator.

Optionally, the coating system may include a controller configured to control operation of the coating system, the controller including a plurality of sensors and a processor.

Optionally, the plurality of sensors may include at least one of a temperature sensor, a flow meter, and a pressure sensor.

Optionally, the processor may be configured to receive signals from the plurality of sensors and to store the received signals in a memory.

Optionally, the processor may be configured to compare the received signals from at least two of the plurality of sensors to determine if a clogging condition exists.

Optionally, the processor may be configured to compare the received signals from the plurality of sensors with predetermined control signals to determine if a clog condition exists.

Optionally, the processor may be configured to receive signals from the plurality of sensors at a first iteration and signals from the plurality of sensors at a second iteration after the first iteration, wherein the processor may be configured to compare the received signals of the second iteration with the received signals of the first iteration to determine if a clogging condition exists.

Optionally, the signals may include temperature and flow rate of the material, and the processor may be configured to compare the temperature and flow rate of the first iteration with the temperature and flow rate of the second iteration, and, if the temperature of the second iteration is within a predetermined threshold compared to the temperature of the first iteration and the flow rate of the second iteration is below a predetermined threshold compared to the flow rate of the first iteration, the processor may be configured to transmit a signal to the applicator positioning assembly to move the applicator to the cleaning position.

Optionally, the coating system may further include a controller configured to control operation of the coating system, the controller including a vision system.

Optionally, the vision system may be positioned onboard the applicator or downstream of the applicator.

Optionally, the vision system may include a camera configured to capture an image of a nozzle through which the material is dispensed from the applicator.

Optionally, the camera may be configured to capture an image of an opening in the nozzle.

Optionally, the controller may be configured to generate one or more signals to actuate the camera to capture the image of the nozzle, process the image to generate a first value based on the residual material on the nozzle, compare the first value to a predetermined value, actuate the applicator positioning assembly, in response to a determination that the first value is outside tolerances set for the predetermined value, to move the applicator to the cleaning position, and actuate the cleaning assembly to remove at least some of the residual material from the applicator.

Optionally, the controller may be further configured to generate one or more signals to actuate the applicator positioning assembly, following the actuation of the cleaning assembly to remove at least some of the residual material from the applicator, to move the applicator to the dispensing position, actuate the camera to capture a second image of the nozzle, process the second image to generate a second value based on the residual material on the nozzle, compare the second value to a predetermined value, and actuate the dispensing assembly to cause dispensing of the material from the applicator.

Optionally, the vision system may include a camera configured to capture an image of a fluid pattern of the material being dispensed.

Optionally, wherein the controller is configured to generate one or more signals to actuate the camera to capture the image of the fluid pattern, process the image to generate actual fluid pattern information of the fluid pattern, compare the actual fluid pattern information to fluid pattern information for the fluid pattern, determine, based on the comparison of the actual fluid pattern information to the fluid pattern information, that the actual fluid pattern is outside tolerances set for the fluid pattern, actuate the applicator positioning assembly, in response to the determination that the actual fluid pattern is outside tolerances set for the fluid pattern, to move the applicator to the cleaning position, and actuate the cleaning assembly to remove at least some of the residual material from the applicator.

Optionally, the image of the fluid pattern may comprise at least one image of the fluid pattern from a first angle and at least one image of the fluid pattern from a second angle different than the first angle.

Optionally, the camera may be configured to move between a first position to capture the at least one image of the fluid pattern from the first angle and a second position to capture the at least one image of the fluid pattern from the second angle.

Optionally, the controller may be configured to determine, based on the image, a three-dimensional model of the fluid pattern, and determine the actual fluid pattern information of the fluid pattern based on the three-dimensional model.

Optionally, the coating system may further include a light source configured to emit light through the fluid pattern of the material dispensed from the dispensing nozzle, the light source positioned to face the fluid pattern so as to direct the emitted light through the fluid pattern.

Optionally, the cleaning assembly may include a cleaning apparatus configured to receive a cleaning material therein and configured to receive the applicator therein when the applicator is in the cleaning position.

Optionally, the method may include measuring a fluid level of the cleaning material, comparing the measured fluid level to a predetermined value, in response to a determination that the measured fluid level is less than the predetermined value, adding cleaning material to raise the fluid level of the cleaning material to be greater than or equal to the predetermined value.

Optionally, the coating system may include a fluid level sensor configured to measure the fluid level of the cleaning material.

Optionally, the coating system may include a gravity-fed reservoir configured to add the cleaning material to raise the fluid level of the cleaning material to be greater than or equal to the predetermined value.

Optionally, the cleaning material may include a solvent.

Optionally, the cleaning apparatus may include an ultrasonic transducer configured to generate ultrasonic waves through the cleaning material to agitate the cleaning material such that cavitation bubbles are formed in the cleaning material.

Optionally, the method may include receiving electronic feedback from the ultrasonic transducer and adjusting operation of the ultrasonic transducer based on the received electronic feedback.

Optionally, the electronic feedback may include at least one of current feedback and phase feedback.

Optionally, adjusting operation of the ultrasonic transducer based on the received electronic feedback may include operating the ultrasonic transducer at its resonant frequency.

Optionally, the cleaning assembly may include a lid configured to be removably attached to the cleaning apparatus such that the cleaning material is enclosed between the cleaning apparatus and the lid and is precluded from moving out of the cleaning apparatus past the lid.

Optionally, the lid may define an aperture therein configured to receive the applicator therethrough.

According to yet another aspect of this disclosure, a method of applying a material to a substrate with a coating system includes dispensing the material onto a substrate using an applicator, the applicator being configured to receive the material therein and to discharge the material therefrom toward the substrate, performing a visual inspection of the applicator using a vision system, based on the visual inspection of the applicator, stopping the dispensing of the material onto the substrate and cleaning the applicator, and after cleaning the applicator, resuming dispensing the material.

Optionally, performing the visual inspection may include visually inspecting a fluid pattern of the material being dispensed.

Optionally, visually inspecting the fluid pattern of the material being dispensed may include capturing, via a camera of the vision system, an image of the fluid pattern of the material being dispensed.

Optionally, the method may further include processing the image to generate actual fluid pattern information of the fluid pattern, comparing the actual fluid pattern information to fluid pattern information for the fluid pattern, determining, based on the comparison of the actual fluid pattern information to the fluid pattern information, that the actual fluid pattern is outside tolerances set for the fluid pattern, in response to the determination that the actual fluid pattern is outside tolerances set for the fluid pattern, moving the applicator from a dispensing position to a cleaning position, and removing at least some of a residual material from the applicator.

Optionally, the image of the fluid pattern may include at least one image of the fluid pattern from a first angle and at least one image of the fluid pattern from a second angle different than the first angle.

Optionally, the method may further include moving the camera between a first position to capture the at least one image of the fluid pattern from the first angle and a second position to capture the at least one image of the fluid pattern from the second angle.

Optionally, the method may further include determining, based on the image, a three-dimensional model of the fluid pattern, and determining the actual fluid pattern information of the fluid pattern based on the three-dimensional model.

Optionally, the method may further include emitting, via a light source, light through the fluid pattern of the material dispensed from the dispensing nozzle, the light source positioned to face the fluid pattern so as to direct the emitted light through the fluid pattern.

Optionally, performing the visual inspection may include visually inspecting, for contamination, a nozzle through which the material is discharged from the applicator.

Optionally, visually inspecting the nozzle may include capturing, via a camera of the vision system, an image of the nozzle.

Optionally, the camera may be configured to capture an image of an opening in the nozzle.

Optionally, the method may further include processing the image to generate a first value based on a residual material on the nozzle, comparing the first value to a predetermined value, in response to a determination that the first value is outside tolerances set for the predetermined value, moving the applicator to the cleaning position, and removing at least some of the residual material from the applicator.

Optionally, the method may further include following removal of at least some of the residual material from the applicator, moving the applicator to a dispensing position, capturing a second image of the nozzle, processing the second image to generate a second value based on the residual material on the nozzle, comparing the second value to a predetermined value, and dispensing the material from the applicator.

Optionally, performing the visual inspection may include visually inspecting the substrate.

Optionally, visually inspecting the substrate may include capturing, via a camera of the vision system, an image of the substrate.

Optionally, the method may further include processing the image to generate a first value based on dispensed material on the substrate, comparing the first value to a predetermined value, in response to a determination that the first value is outside tolerances set for the predetermined value, moving the applicator to the cleaning position, removing at least some of a residual material from the applicator.

Optionally, the first value may be representative of at least one of placement of and quantity of the dispensed material on the substrate.

Optionally, the method may further include following removal of at least some of the residual material from the applicator, moving the applicator to a dispensing position, capturing a second image of the substrate, processing the second image to generate a second value based on dispensed material on the substrate, comparing the second value to a predetermined value, and dispensing the material from the applicator.

Optionally, the applicator may be in an operating position when the dispensing step is performed, and the method may further include moving the applicator to a cleaning position during cleaning of the applicator.

Optionally, the step of cleaning the applicator may include contacting the applicator with a cleaning material for a predetermined duration.

Optionally, the method may further include measuring a fluid level of the cleaning material, comparing the fluid level to a predetermined value, and in response to a determination that the fluid level is less than the predetermined value, adding cleaning material to raise the fluid level to be greater than or equal to the predetermined value.

Optionally, the cleaning material may include a solvent.

Optionally, the method may further include actuating an ultrasonic transducer to agitate the cleaning material to form cavitation bubbles in the cleaning material.

Optionally, the method may include receiving electronic feedback from the ultrasonic transducer and adjusting operation of the ultrasonic transducer based on the received electronic feedback.

Optionally, the electronic feedback may include at least one of current feedback and phase feedback.

Optionally, adjusting operation of the ultrasonic transducer based on the received electronic feedback may include operating the ultrasonic transducer at its resonant frequency.

### BRIEF DESCRIPTION OF THE DRAWINGS

The present application is further understood when read in conjunction with the appended drawings. For the purpose of illustrating the subject matter, there are shown in the drawings exemplary aspects of the subject matter; however, the presently disclosed subject matter is not limited to the specific methods, devices, and systems disclosed. In the drawings:

FIG. 1 depicts a schematic of a coating assembly system according to an aspect of this disclosure;

FIG. 2 depicts a schematic of a memory of a processor of a coating assembly system according to an aspect of this disclosure;

FIG. 3 depicts a perspective view of part of a cleaning assembly system according to an aspect of this disclosure:

FIG. 4 depicts another perspective view of the part of the cleaning assembly system of FIG. 3;

FIG. 5 depicts another perspective view of the part of the cleaning assembly system of FIG. 3, showing the applicator disposed therein according to an aspect of this disclosure:

FIG. 6 depicts a perspective view of a part of a cleaning assembly system according to another aspect of this disclosure:

FIG. 7 depicts a perspective view of the part of the cleaning assembly system of FIG. 6, showing the applicator disposed therein according to an aspect of this disclosure:

FIG. 8 depicts a side cross-sectional view of a cleaning assembly system according to yet another aspect of this disclosure:

FIG. 9 depicts a flow chart representing a clog detection process according to an aspect of this disclosure;

FIG. 10 depicts a schematic of a coating assembly according to another aspect of this disclosure:

FIG. 11 depicts a schematic of a machine learning unit according to an aspect of this disclosure:

FIG. 12 depicts a schematic of a learning module of the machine learning unit of FIG. 11 according to an aspect of this disclosure:

FIG. 13 depicts a flow chart representing a process for predicting a future occurrence of a clogging condition according to an aspect of this disclosure:

FIG. 14 depicts a flow chart representing a process for calibrating flow rate of a material applied to one or more substrates through a nozzle of a coating system according to an aspect of this disclosure:

FIG. 15 depicts a flow chart representing a process for visually inspecting a dispensing nozzle according to an aspect of this disclosure; and

FIG. 16 depicts a flow chart representing a process for visually inspecting a fluid pattern according to an aspect of this disclosure.

Aspects of the disclosure will now be described in detail with reference to the drawings, wherein like reference numbers refer to like elements throughout, unless specified otherwise.

### DETAILED DESCRIPTION OF ILLUSTRATIVE EMBODIMENTS

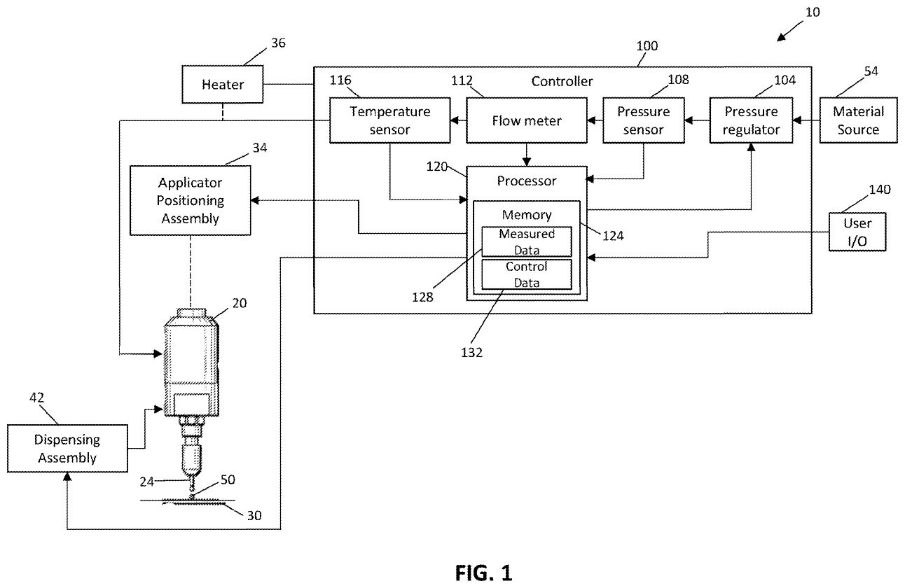

Referring to FIG. 1, an exemplary conformal coating system 10 is depicted having a conformal coating applicator or dispenser, hereinafter an applicator 20. The applicator 20 is configured to receive one or more conformal coating materials 50 from a material source 54. The applicator 20 has an applicator tip 24, through which the applicator 20 is configured to dispense the received material 50 onto one or more substrates 30. The dispensing of the material 50 can be controlled by one or more dispensing assemblies 42 within, and/or operably connected to, the applicator 20. The dispensing assembly 42 can include movable valves, valve components, and/or the like and can include an actuator to cause movement of the valve or valve components that may be implemented by, for example, a solenoid. The coating system 10 can include a heater 36 configured to heat the coating material 50. The heater 36 can be disposed adjacent the material source 54, the applicator 20, or elsewhere in the coating system 10. In some aspects, the coating system 10 can include a plurality of heaters 36.

The substrate 30 can include a printed circuit, a printed circuit board (PCB), another electronic component, and/or the like configured to receive a conformal coating thereon. In some aspects, one or more substrates 30 may be coated in a batch mode. One or more of the substrates 30 may be moved continuously past the applicator 20, for example, by a conveyor (not shown). In some aspects, the applicator 20 may be moved relative to the substrate 30. The applicator 20 may be operably connected to an applicator positioning assembly 34. The applicator positioning assembly 34 may be configured to translate the applicator 20 relative to the substrate 30 along one, two, or three directional axes that are each orthogonal to any of the other axes. In some aspects, the applicator positioning assembly 34 may be configured to rotate the applicator 20 about the one, two, or three directional axes. The applicator positioning assembly 34 can include a drive coupled to independently controllable motors (not shown) in a known manner. The applicator positioning assembly 34 is configured to rapidly move the applicator 20 with respect to the substrate 30. Movement of the applicator 20 may align the applicator 20 with the substrate 30 based on desired orientation. In some aspects, the applicator positioning assembly 34 may be configured to move the applicator 20 between an operating position and a cleaning position. In the operating position, the applicator 20 is configured to dispense the material 50 onto the substrate 30. The applicator 20 may be movable relative to the substrate 30 when in the operating position. In the cleaning position, the applicator 20 may be spaced away from the substrate 30 and is precluded from dispensing the material 50 onto the substrate 30.

The conformal coating system 10 may further include one or more controllers configured to send and/or receive signals to direct operation of the one or more components of the conformal coating system 10. A system controller 100 may be configured to send and/or receive data and/or signals to and from one or more components of the conformal coating system 10 to control operation of the conformal coating system 10. The controller 100 can be configured to operate the one or more heaters 36 and/or other components of the conformal coating system 10. The controller 100 can include, or be operatively connected to, one or more sensors configured to detect and measure various parameters of the coating system 10.

With continued reference to FIG. 1, the controller 100 can include, or be connected to, a pressure sensor 108. The pressure sensor 108 may be configured to detect and measure pressure of the material 50 at one or more points along the flow path as the material 50 is moved from the material source 54 towards the applicator 20. The controller 100 may include, or be connected to, a flow meter 112 that may be configured to detect and measure the flow of the material 50 at one or more points along a flow path as the material 50 is moved from the material source 54 towards the applicator 20. The controller 100 may include, or may be connected to, a temperature sensor 116 configured to measure the temperature of the material 50 at one or more points along a flow path as the material 50 is moved from the material source 54 towards the applicator 20. In some aspects, the coating system 10 may include a plurality of pressure sensors 108, flow meters 112, and/or temperature sensors 116, and this disclosure is not limited by the particular quantity or respective arrangement of the various sensors and meters described. It should be appreciated that the particular arrangement of the components described above can be according to any suitable arrangement and can depend on dimensions of the individual components selected, the quantity of selected components, on manufacturing constraints, and/or on other considerations common in the industry. The arrangement depicted in the schematic of FIG. 1 is exemplary and is not limiting in terms of relative positioning of the described components.

The controller 100 can include a processor 120 configured to receive signals from the pressure sensor 108, flow meter 112, and/or temperature sensor 116. Additionally, the controller 100 may include an analog to digital converter, a digital to analog converter, at least one filter, and/or the like to prepare and condition the signals. The received signals may include measured values of material pressure, material flow rate, and/or material temperature, respectively. The processor 120 may include a programmable logic controller (PLC), a microprocessor-based controller, a hardened personal computer, or other conventional programmable control device capable of carrying out the functions described herein as will be understood by those of ordinary skill. The processor 120 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The processor 120 may be configured to connect with and communicate with a memory 124 configured to receive and store the measured values. The memory 124 may include a random access memory (RAM) and/or a computer-readable storage medium, such as a read-only memory (ROM) or non-volatile RAM (NVRAM), for storing basic routines for starting and/or operating the controller 100 and/or another component of the coating system 10 and to transfer information between the various components and devices of the coating system 10. The memory 124 may also store other software components necessary for the operation of the controller 100 and/or other components of the coating system 10 including an operating system, software implementing the process 170, software implementing a machine learning unit 200, software implementing a learning module 208, and/or the like. The processor 120 may include, or may be connected to, or otherwise in communication with, computer-readable storage media to store and retrieve information, such as program modules, data structures, or other data. It should be appreciated by those skilled in the art that computer-readable storage media may be any available media that provides for the storage of non-transitory data and that may be accessed by the processor 120. By way of example and not limitation, the computer-readable storage media may include volatile and non-volatile storage media, transitory computer-readable storage media, non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

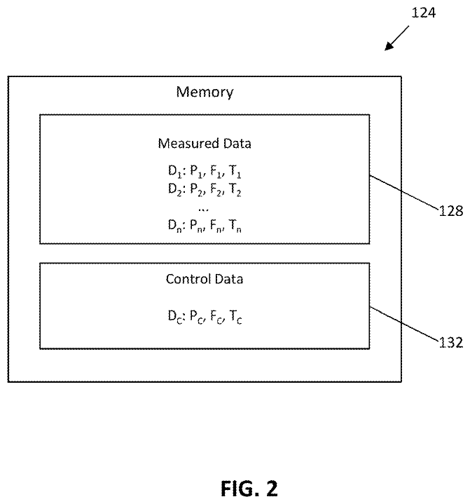

Referring to FIG. 2, the memory 124 may include repositories for measured data 128 and for control data 132. The measured data 128 may include the measured values received from one or more of the pressure sensor 108, the flow meter 112, the temperature sensor 116, and/or another component of the coating system 10. Additionally, the measured data 128 may include acquisition time, other environmental data, and/or the like The control data 132 may include predefined information that can be preprogrammed into the processor 120 prior to operation of the coating system 10. In operation, the processor 120 may compare the measured data 128 with the control data 132, as will be described in detail below.

The processor 120 may also be configured to transmit one or more signals to one or more components of the coating system 10. In some aspects, the processor 120 may be configured to transmit one or more signals to components outside of the coating system 10, for example, to, or through, a wired connection, a wireless connection, a network connection, a cloud network connection (not shown), and/or the like.

Referring again to FIG. 1, the coating system 10 may include a pressure regulator 104 configured to adjust the pressure of the material 50 that one or more points flowing between the material source 54 and the applicator 20. The pressure regulator 104 may include one or more valves and/or one or more pumping mechanisms. The pressure regulator 104 may be actuated to selectively increase or decrease the pressure of the material 50. The processor 120 may send one or more signals to the pressure regulator 104 to cause the pressure regulator 104 to change the pressure of the material 50 and/or otherwise regulate flow of the material 50. The greater the pressure of the material 50, the higher the flow rate of the material 50 may be within the coating system 10: conversely, the lower the pressure of the material 50, the lower the flow rate of the material 50 may be within the coating system 10. The processor 120 may be configured to control the pressure regulator 104 to maintain a desired pressure of the material 50. If the pressure of the material 50, as measured by the pressure sensor 108, is outside of a predetermined pressure range (e.g., above an upper threshold of the predetermined range or below a lower threshold of the predetermined range), the processor 120 can send a signal to the pressure regulator 104 to decrease or increase, respectively, the pressure of the material 50 such that the measured pressure is within the predetermined pressure range. In some aspects, reference can be made to a single pressure value rather (e.g., either the upper threshold or the lower threshold) instead of a range of values. In some aspects, the predetermined range and/or predetermined value can be configured to be varied depending on other parameters of the coating system 10, such as temperature, flow rate, duration of operation, or other operating characteristics.

In some aspects, if the flow rate of the material 50 within the coating system 10, as measured by the flow meter 112, is outside of a predetermined flow rate range, the processor 120 may cause the pressure regulator 104 to increase or decrease the pressure accordingly to increase or decrease the flow rate, respectively, such that the measured flow rate is within the predetermined flow rate range. It should be appreciated that the predetermined flow rate range may, instead, be a singular predetermined flow rate value rather than a range of values, and the coating system 10 may be configured to react to a measured flow rate value that is greater than, less than, or equal to the predetermined flow rate value. In some aspects, the predetermined range and/or predetermined value can be configured to be varied depending on other parameters of the coating system 10, such as temperature, pressure, duration of operation, or other operating characteristics.

Flow rate adjustment may generally be accomplished by any suitable means for suiting a particular application. By way of non-limiting example, a representative system and method for calibrating flow is described in commonly-owned U.S. Pat. No. 11,185,879, the disclosure of which is hereby incorporated by reference herein in its entirety for all purposes.

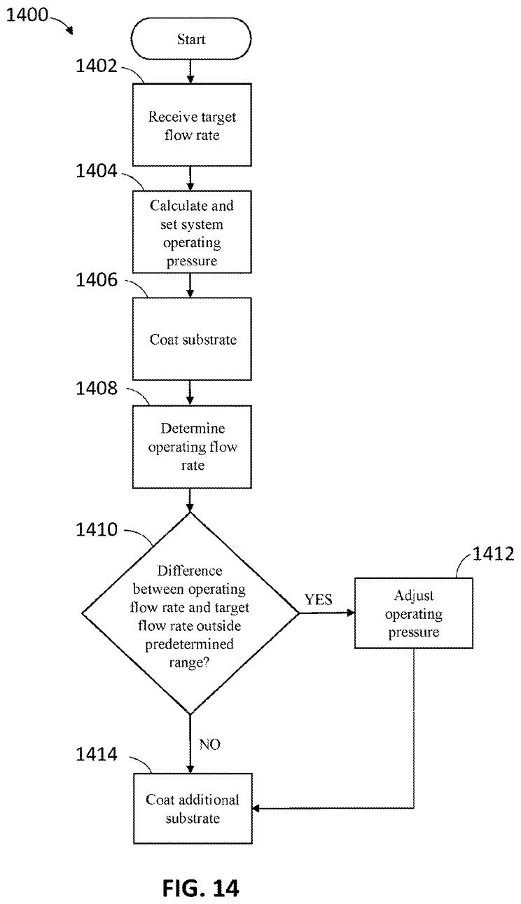

By way of non-limiting example, FIG. 14 illustrates a flow diagram of an exemplary process 1400 for calibrating flow rate of a material applied to one or more substrates through a nozzle of a coating system. The process 1400 may be executed, at least in part, by a controller 18. Generally, the process 1400 may include a flow control routine (steps 1402-1414) including calculating and setting a first operating pressure of the coating system 1410 based upon a received target flow rate for the material through the nozzle and a pressure-flow relationship (i.e., a relationship between operating pressure of the coating system and flow rate of the material through the nozzle). When a difference between a determined operating flow rate and the received target flow rate is outside of a predetermined control range (e.g., +a predetermined percentage of the target flow rate), the process 1400 may adjust the operating pressure of the coating system to a second operating pressure prior to coating one or more additional substrates.

At step 1402 of the process 1400, the coating system may receive a target flow rate for the material through the nozzle. For example, an operator may enter the target flow rate into an HMI device. The target flow rate may be stored in a memory of the controller for use in the process 1400. In accordance with aspects of the disclosure, the target flow rate received by the coating system may be calculated, manually or automatically, based upon received operating parameters of the coating system. The received operating parameters may include, e.g., the target coating thickness of the material, the target coating width of the material, the solids percentage of the material, and the velocity of the applicator of the coating system. The operating parameters may, for example, be input by the operator into the HMI device and stored in the memory of the controller for automatic calculation of the target flow rate.

Calculation of target flow rate may include solving, manually or automatically, the following target flow rate equation:

$$( \frac{T \times W}{\frac{P}{100}} ) \times S = FR$$

In the target flow rate equation, “T” is the received target coating thickness of the material, “W” is the received target coating width of the material, “P” is the received solids percentage of the material, “S” is the received velocity of the applicator, and “FR” is the calculated target flow rate. Solving the equation may also include, where appropriate, unit conversions to normalize any unit discrepancies between the input operating parameters, as would be readily understood by a person having ordinary skill in the art. When the target flow rate is automatically calculated, the controller may recall the operating parameters stored in the memory and may utilize the operating parameters to solve the target flow rate equation for FR, i.e., the calculated target flow rate for the material through the nozzle. Accordingly, the calculated target flow rate may correspond to the target flow rate received at step 1402 utilized in the process 1404.

According to aspects of the disclosure, it may be determined that the target flow rate calculated using the operating parameters input by the operator is outside of a predetermined flow rate capacity range of the coating system. The predetermined flow rate capacity range of the coating system may be a range of flow rates that may be reliably achieved by the coating system, which may be a function of the capacity of the coating system and/or of properties of the coating material, as would be readily understood by a person having ordinary skill in the art. In response to a determination that the calculated target flow rate is outside of the predetermined flow rate capacity range, the velocity of the applicator operating parameter may be adjusted to bring the calculated target flow rate within the predetermined flow rate capacity range. Adjusting the velocity of the applicator operating parameter while keeping constant the remaining operating parameters entered into the target flow rate equation that affect coating properties (i.e., the target coating thickness, the target coating width of the material, the solids percentage of the material) allows for an adjustment of the calculated target flow rate within the predetermined flow rate capacity range without altering the coating characteristics desired by the operator. The adjustment of the velocity of the applicator operating parameter may be the result of an iterative process. For example, the velocity of the applicator operating parameter may be iteratively adjusted and reentered until the target flow rate calculated from the target flow rate equation falls within the predetermined flow rate capacity range.

Alternatively, the adjustment of the velocity of the applicator operating parameter may be the result of a calculation solving the target flow rate equation for the velocity of the applicator operating parameter using a set target flow rate and holding all other operating parameters constant. The set target flow rate may, for example, be an outer bound of the predetermined flow rate capacity range, or may alternatively be any flow rate within the predetermined flow rate capacity range. As a non-limiting numeric example, the predetermined flow rate capacity range of an exemplary coating system may be between 0.1 ml/min and 10.0 ml/min. If a target flow rate using the operating parameters input by the operator is calculated to be 12.0 ml/min (i.e., outside of the predetermined flow rate capacity range), the target flow rate may be set to 10.00 ml/min (i.e., the outer upper bound of the predetermined flow rate capacity range of the exemplary coating system 10). The velocity of the applicator operating parameter may be adjusted by solving the target flow rate equation for the velocity of the applicator operating parameter using the set target flow rate and holding all other operating parameters constant. That is, the target flow rate equation may be rewritten to solve for the velocity of the applicator as the following adjusted velocity equation:

$$( \frac{\frac{P}{100}}{T \times W} ) \times {FR}^{′} = {S}^{′}$$

In the adjusted velocity equation, “T” is the received target coating thickness of the material, “W” is the received target coating width of the material, “P” is the received solids percentage of the material, “FR′” is the set target flow rate, and “S′” is the adjusted velocity of the applicator 16. Solving the equation may also include, where appropriate, unit conversions to normalize any unit discrepancies between the input operating parameters, as would be readily understood by a person having ordinary skill in the art. The adjusted velocity of the applicator 16 may, for example, be automatically calculated whereby the controller may recall the operating parameters stored in the memory and the set target flow rate, which may be utilized to solve the adjusted velocity equation for S′, i.e., the adjusted velocity of the applicator. Accordingly, the coating system may be operated at the adjusted velocity of the applicator and at the set target flow rate. The set target flow rate may correspond to the target flow rate received at step 1402.

At step 1404, the first operating pressure of the coating system may be calculated. The first operating pressure of the coating system may be calculated based upon the target flow rate for the material through the nozzle and the pressure-flow relationship. In addition, the operating pressure of the coating system may be set to the first operating pressure. For example, under command of the controller the operation of the pump of the pressurized liquid supply may be adjusted to increase or decrease the operating pressure of the material supplied to the applicator to set the coating system to the first operating pressure.

The pressure-flow relationship may be a function of the structure of the nozzle and properties of the material that passes through the nozzle. The pressure-flow relationship may be used, for example, to determine an operating pressure of the coating system (e.g., the first operating pressure) that is predicted to achieve a particular operating flow rate of the material ejected from the nozzle (e.g., the target flow rate) and to result in coating characteristics desired by the operator (e.g., the target coating thickness). In embodiments, the pressure-flow relationship may be entered by an operator into the HMI device and may be stored in the memory of controller for use in the process 1400.

Alternatively, the pressure-flow relationship may be calculated. For example, the material may be ejected from the nozzle, e.g., into a container while the coating system operates at a first calibrating pressure and a first flow rate of the material ejected from the nozzle may be determined. As the material is ejected from the nozzle, the amount of material ejected and the time that the material is ejected may be measured, which may be used to determine the first flow rate. For example, as the material flows from the pressurized liquid supply and out the applicator, the flow meter may transmit to the controller a count or electrical pulse for each fixed amount of material passing through the flow meter. As another example, the amount of material ejected may be measured according to a differential in the weight of the remaining material in the pressurized liquid supply. According to yet another example, the amount of material collected in the container may be measured. The amount of material may be measured volumetrically and/or by weight. The controller may, for example, measure the total time that the material is ejected. The first flow rate of the material may be determined from the measured amount of material ejected over the measured amount of time that the material was ejected, as would be readily understood by a person having ordinary skill in the art.

The operating pressure of the coating system may be adjusted to a second calibrating pressure that is different from (i.e., higher or lower than) the first calibrating pressure. The coating system may eject the material from the nozzle while the coating system operates at the second calibrating pressure and a second flow rate of the material ejected from the nozzle may be determined. That is, as the material is ejected from the nozzle, the amount of material ejected and the amount of time that the material is ejected may be measured (e.g., in accordance with any of the above described techniques), which may be used to calculate the second flow rate.

The pressure-flow relationship may be calculated based upon the first calibrating pressure, the first flow rate, the second calibrating pressure, and the second flow rate. In addition to the first and second calibrating pressures and corresponding first and second flow rates, the pressure-flow relationship may be calculated based upon, e.g., third, fourth . . . n calibrating pressures and corresponding third, fourth . . . n flow rates, which may be determined in a manner similar to the first and second flow rates described above. The pressure-flow rate relationship may be calculated as, e.g., a simple linear regression model, based upon the calibrating pressures and corresponding flow rates, as would be readily understood by a person having ordinary skill in the art. The simple linear regression model may be used as a predictive function to calculate a pressure/flow rate based upon a known flow rate/pressure. Accordingly, the simple linear regression model may be used to calculate the first operating pressure of the coating system based upon the target flow rate received at step 1402 and the operating pressure of the coating system may be set to the first operating pressure.

At step 1406, a substrate, or portion thereof, may be coated with the material. That is, at least a part of the substrate may be sprayed with the material flowing through the nozzle while the coating system is operated at the first operating pressure.

At step 1408, an operating flow rate of the material may be determined. For example, the operating flow rate of the material flowing through the coating system during the coating of the substrate may be determined in situ. That is, as the substrate is coated with the material, the amount of material may be measured over a measured amount of time. For example, as the material flows from the pressurized liquid supply and out the applicator, a flow meter may transmit to the controller a count or electrical pulse for each fixed amount of material passing through the flow meter over a measured period of time. As another example, the amount of material applied to the substrate may be measured according to a differential in the weight of the remaining material in the pressurized liquid supply. The amount of material may be measured volumetrically and/or by weight.

Alternatively, after the substrate is sprayed with the material, the material may further be ejected from the nozzle, e.g., into a container while the coating system operates at the first operating pressure and an operating flow rate of the material ejected from the nozzle may be determined. For example, as the material flows from the pressurized liquid supply and out the applicator into the container, the flow meter may transmit to the controller a count or electrical pulse for each fixed amount of material passing through the flow meter. As another example, the amount of material ejected into the container may be measured according to a differential in the weight of the remaining material in the pressurized liquid supply. According to yet another example, the amount of material collected in the container may be measured. The amount of material may be measured volumetrically and/or by weight. The controller, for example, may measure the total time that the material is ejected. The operating flow rate of the material at the first operating pressure may be determined from the measured amount of material over the measured amount of time that the material was sprayed/ejected, as would be readily understood by a person having ordinary skill in the art.

At step 1410, the operating flow rate of the material determined at step 1408 may be compared to the received target flow rate and it may be determined whether the determined operating flow rate is outside of a predetermined control range. The predetermined control range may, for example, be within ±5% of the target flow rate. In another example, the predetermined range may be within ±1% of the target flow rate. If the difference between the determined operating flow rate and the target flow rate is outside of the predetermined control range, the process 1400 may proceed to step 1412. If, however, the difference between the determined operating flow rate and the target flow rate is within the predetermined range, the process may proceed directly to step 1414.

At step 1412, the operating pressure of the coating system may be adjusted to a second operating pressure. For example, under command of the controller, the operation of the pump of the pressurized liquid supply may be adjusted to increase or decrease the operating pressure of the material supplied to the applicator to set the operating pressure of the coating system to the second operating pressure. In one example, the operating pressure of the coating system may be increased or decreased from the first operating pressure to the second operating pressure in proportion to the determined difference between the determined operating flow rate and the target flow rate. As a non-limiting numeric example, if the determined operating flow rate is 2% above the target flow rate, the second operating pressure may be 2% less than the first operating pressure.

In another example, the pressure-flow relationship between operating pressure of the coating system and flow rate of the material through the nozzle may be calculated or recalculated to determine the second operating pressure necessary to achieve the target flow rate. That is, alternately or in addition to the determination that the difference between the determined operating flow rate and the target flow rate is outside of the predetermined control range, it may be determined that at least one of a property of the material (e.g., viscosity) and the structure of the nozzle (e.g., an expansion due to an increase in temperature) has changed during operation of the coating system. As result, the pressure-flow relationship between operating pressure of the coating system 10 and flow rate of the material through the nozzle utilized in step 1404 may no longer be representative of the material/coating system and the pressure-flow relationship may be recalculated or recalibrated, in accordance with any of the above described techniques.

Upon completion of the flow control routine, at step 1414, additional substrates may be coated with the material. At least some of the steps of the process 1400 may be iterative. For example, as additional substrates are coated in step 1414, this may also be considered as restarting the process 1400 at step 1406, whereby the flow control routine of steps 1406-1414 may continue to iteratively adjust the pressure of the coating system, when appropriate and as set forth at steps 1410 and 1412, as it coats the additional substrates, and so forth.

The processor 120 may be configured to automatically adjust the pressure and/or the flow rate as described above. Alternatively, the processor 120 may be configured to determine that the pressure and/or the flow rate are outside of their respective predetermined ranges and alert a user of the coating system 10 through a human machine interface. The user can then instruct or otherwise control the processor 120 through the human machine interface to send a signal to the pressure regulator 104 to increase or decrease the pressure of the material 50 within the coating system 10. The user can transmit one or more instruction to the processor 120 via the human machine interface, such as a user input/output assembly 140 operably connected to the coating system 10. The processor 120 may transmit one or more signals (e.g., indicative of pressure and/or flow rate being outside of their respective predetermined ranges) to the input/output assembly 140. In some aspects, the input/output assembly 140 may include a display configured to visually depict a signal from the processor 120 (e.g., an LCD screen, projector, or other output device). The input/output assembly 140 may include an audio device (e.g., a speaker) to auditorily generate a signal from the processor 120. The input/output assembly 140 may include one or more input devices actuatable by the user, such as a button, lever, slider, touch-screen, microphone, keyboard, mouse, touchpad, electronic stylus, and/or the like, through which the user can input and transmit a command to the processor 120. The input/output assembly 140 may be physically connected to the coating system 10 or, alternatively, may be wirelessly connected via one or more known wireless transmission protocols, such as Wi-Fi, Bluetooth, NFC, infrared, radio, or other suitable wireless communication methods. The coating system 10 may include a plurality of input/output assemblies 140.

During operation, the coating system 10 may be configured to detect various clogging conditions of the applicator 20. Specifically, the processor 120 may be configured to detect presence of a formed clog, formation of a clog, and/or conditions favorable for formation of a clog in the applicator 20. For purposes of this disclosure, clogging can be referred to as accumulation, solidifying, and/or curing of residual portions of the material 50 on the applicator 20, for example, on the applicator tip 24.

The viscosity of the material 50 may be affected by the temperature of the material 50. A change in temperature can cause a change in viscosity and/or the like, which, in turn, can cause a change in flow rate. As the temperature of the material 50 increases, the viscosity may decrease: conversely, as the temperature of the material 50 decreases, the viscosity may increase. The processor 120 may be configured to utilize measured temperature values received from the temperature sensor 116, the measured pressure values received from the pressure sensor 108, and/or the measured flow rate values received from the flow meter 112 within the coating system 10 to determine if a clogging condition is met. The coating system 10 may include a desired predetermined temperature range at which the material 50 is desired to be kept. The predetermined temperature range may include a lower threshold temperature value, an upper threshold temperature value, and all temperature values between the upper and lower threshold temperature values. In some aspects, the predetermined temperature may include a singular temperature value rather than a range of values. The predetermined range and/or predetermined value can be configured to be varied depending on other parameters of the coating system 10, such as pressure, flow rate, duration of operation, or other operating characteristics.

The processor 120 may receive continuous or intermittent results from one or more of the pressure sensor 108, the flow meter 112, and the temperature sensor 116. It will be appreciated that the specific frequency of received measurements can depend on the operating parameters of the coating system 10, a type of the material 50 utilized, a type of the substrate 30 utilized, manufacturing constraints, operator preference, and/or the like, and this disclosure is not limited to a particular frequency or pattern of data acquisition from the respective sensors.

The received results from the one or more sensors listed above can be stored in the memory 124 of the processor 120, for example, in a measured data section 128. The storage of data can be iterative, such that each subsequent data value is stored sequentially after a preceding data value. The processor 120 may store a plurality of measured data values from one or more of the sensors described above in data sets based on when the measured data values were received and/or otherwise obtained. For example, measured pressure, flow rate, and/or temperature values received at a first time point P1 may be stored in a first data set D1; a subsequent receiving of measured pressure, flow rate, and/or temperature values at a second time point P2 may be stored in a second data set D2 in the memory 124. This way, values in the first data set D1 can be compared to values in the second data set D2. The processor 120 may be configured to record a plurality of pressure values P1, P2, . . . , Pn, a plurality of flow rate values F1, F2, . . . . Fn, and/or a plurality of temperature values T1, T2, . . . , Tn, where the subscript corresponds to separate continuous or intermittent data value acquisitions from the respective sensors listed above. The processor 120 may group and store the received values into a plurality of data sets D1, D2, . . . , Dn, where the values P1, F1, and/or T1 correspond to a data set D1, values P2, F2, and/or T2 correspond to a data set D2, and values Pn, Fn, and Tn correspond to a data set Dn.

The processor 120 may be configured to compare the received values with other received values and/or with preprogrammed control values. The processor 120 can compare values of one data set, for example the second data set D2 having values P2, F2, and T2, with those of another data set, for example, the first data set D1 having values P1, F1, and T1. In some aspects, the memory 124 may include a control data section 132 configured to receive and store control values. The control values can be programmed by the user prior to operating the coating system 10. Alternatively, the control values can be factory programmed prior to operating the coating system 10. The control values may include values for pressure, flow rate, and/or temperature. For example, the control data section 132 may include a control data set DC that includes a control pressure value PC, a control flow rate value FC, and/or a control temperature value TC. The processor 120 may be configured to compare any one of the data sets D1, D2, . . . , Dn of the measured data section 128 with the control data set DC in the control data section 132.

The processor 120 may be configured to compare any data sets of D1, D2, . . . , Dn with one or more of the data sets D1, D2, . . . . Dn and/or with the control data set DC. The result of the comparison can be indicative of sufficient material flow, indicative of formation of a clog, and/or the like. The comparison of values, for example measured values and/or control values related to pressure, flow rate, and/or temperature, can include calculating whether one of the values is within an acceptable deviation from another value to which the one value is compared. For comparison purposes, acceptable ranges for values (and/or individual values) can be preprogrammed into the processor 120 by the user or by a program of the coating system 10. Each range is defined by a lower threshold below the comparison value and by an upper threshold above the comparison value. The lower and upper thresholds may be determined based on operating parameters of the coating system 10, a type of the material 50 being used, an environment of the coating system 10, manufacturing constraints, and/or other parameters that determine desired values (e.g., pressure, flow rate, and/or temperature values). The lower and upper thresholds may be defined by an acceptable deviation value that is subtracted from the comparison value or added to the comparison value, respectively. Although predetermined values are described as ranges of values throughout this application, it should be understood that the predetermined values can alternatively include a singular value or a plurality of values rather than a numerical range of values.

If the measured value is within the acceptable range, the processor 120 can indicate a first signal, for example, indicate that no issues exist, continue operating, and/or provide an alert to the user regarding the comparison result. If the measured value is outside of the acceptable range, the processor 120 can indicate a second signal different from the first signal, for example, to indicate an operative fault, change in an operational parameter of the coating system 10, and/or provide an alert to the user regarding the comparison result. For example, if a control temperature value TC is 21 degrees C. and an acceptable deviation value is 2 degrees C. the lower threshold would be 19 degrees C., the upper threshold would be 23 degrees C., and the acceptable range would be between 19 and 23 degrees C. If the control temperature value TC is used as a comparison value for a first temperature value T1 of 20 degrees C., then the first temperature value of 20 degrees C. would be within the acceptable range, and the processor 120 can issue a first signal. If the first temperature value T1 is 18 degrees C., then the first temperature value T1 is outside of the acceptable range, and the processor 120 can issue a second signal. In some aspects, the processor 120 may determine how much outside of the acceptable range the measured value is. In aspects having a singular predetermined value or a plurality of predetermined values instead of a range of values, the above steps can include determining if the measured value is greater than, less than, or equal to the one or more predetermined values. It will be appreciated that the above example is for illustrative purposes only, and this disclosure is not limited to the particular values described above.

The processor 120 may compare data sets to compare their respective temperature and flow rate values to determine if a clog is present, if conditions are favorable for a clog to form, and/or the like. The comparison process can be performed continuously or iteratively in predetermined intervals during operation of the coating system 10. The comparison can be between values in the measured data 128 and the control data 132 and/or between subsequent data sets of the measured data 128. For example, comparison can be performed between a first data set D1 and a second data set D2 that is measured after the first data set D1. If, during such a comparison, the processor 120 determines that the second measured temperature value T2 of the second data set D2 is in an acceptable range relative to the first measured temperature value T1 of the first data set D1, but the second flow rate value F2 is below the lower threshold of the acceptable range defined for the first flow rate value F1, such a result could indicate formation of a clog. That is, the processor 120 may be configured to determine whether the temperature of the material 50 remained the same (within an acceptable range) while the flow rate of the material 50 decreased. At this stage, the processor 120 may send a first signal associated with identification of a clog or of a condition favorable for formation of a clog. If, alternatively, the processor 120 determines that the second measured temperature value T2 is below the lower threshold relative to the first measured temperature value T1, and the second flow rate value F2 is also below the lower threshold of the acceptable range defined for the first flow rate value F1, such a result could indicate a decrease in pressure of the material 50 within the coating system 10. This can be corroborated by a comparison of the first measured pressure value P1 with the second measured pressure value P2. In such a case, the processor 120 can send a second signal different from the first signal indicating that the pressure has decreased.

In some aspects, the second signal can include a signal sent to the pressure regulator 104 to increase the pressure of the material 50. It will be understood that, depending on the results of the comparison of the temperature and flow rate values of the material 50 within the coating system 10, the processor 120 can send a signal to the pressure regulator 104 to decrease the pressure of the material 50.

The first signal can include sending an alert to the user via one or more of the input/output assemblies 140 and/or another communications device. The first signal can also include a signal to change operation parameters of the coating system 10, such as movement of the material 50 through the coating system 10, adjusting pressure via the pressure regulator 104, adjusting dispensing from the applicator 20 via the dispensing assembly 42, controlling introduction or movement of the substrate 30 relative to the applicator 20, and/or causing the applicator positioning assembly 34 to move the applicator 20.

In some aspects, the first signal can include an instruction to the applicator positioning assembly 34 to move the applicator 20 from the operating position to the cleaning position. The first signal may further include an instruction to the applicator positioning assembly 34 to perform a cleaning operation, as will be described further below.

The processor 120 can continue comparing values as described above. If the applicator 20 requires cleaning and is moved to the cleaning position, the processor 120 may make a further comparison process and transmit another first or second signal. When the applicator 20 is in the cleaning position, and the processor 120 may transmit a second signal indicative of no clogging, the second signal may further include a signal to the applicator positioning assembly 34 to move the applicator 20 from the cleaning position to the operating position.

Movement of the applicator 20 between the operating and cleaning positions can be actuated manually by the user via one or more of the input/output assemblies 140.

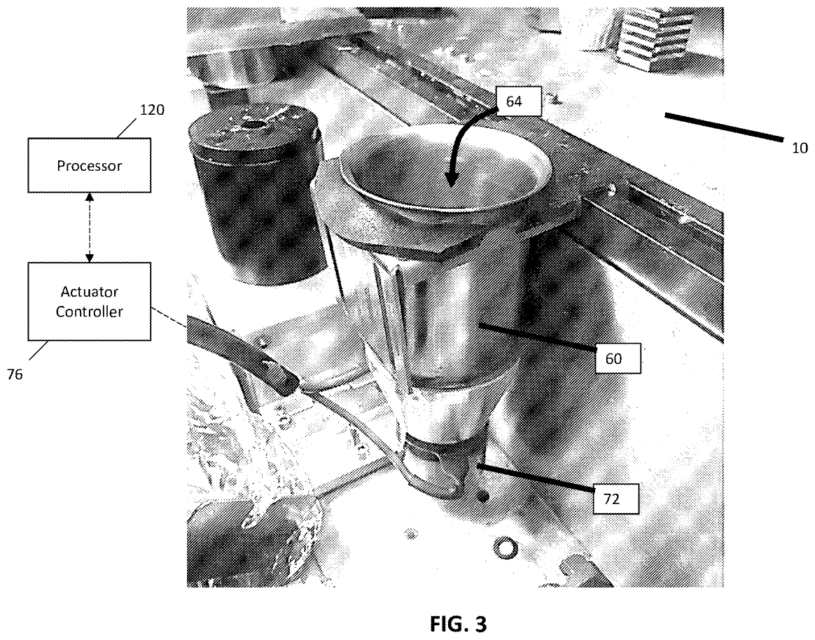

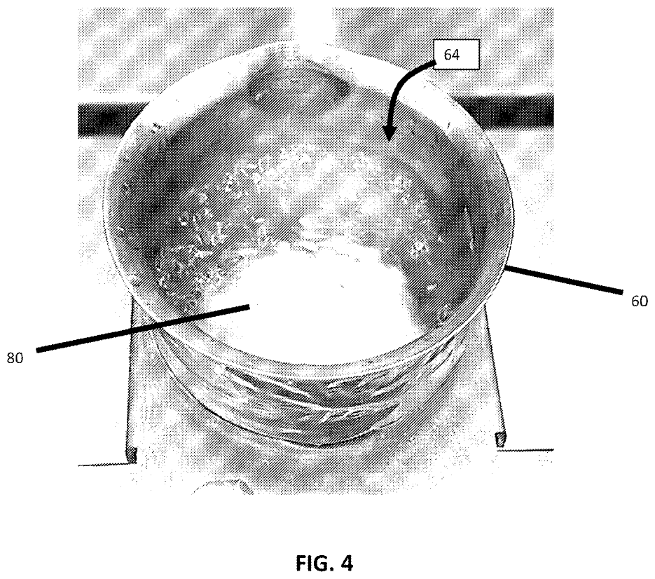

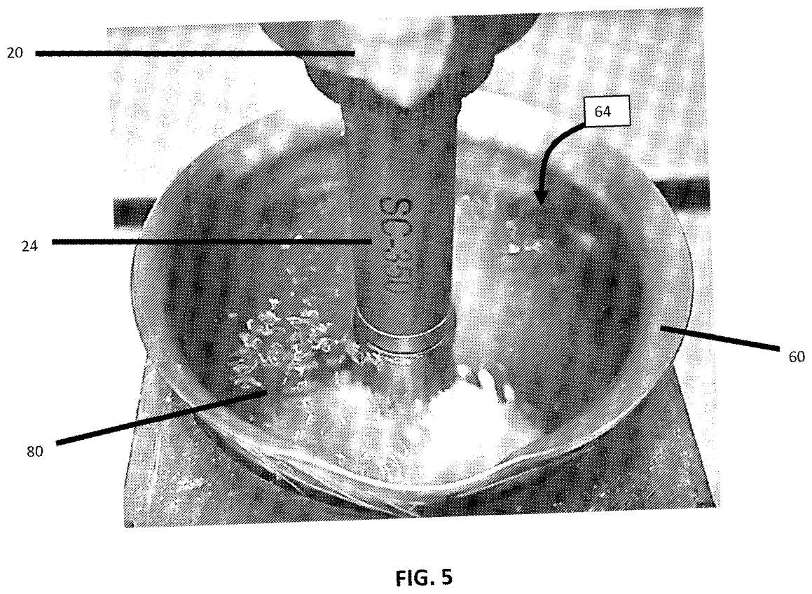

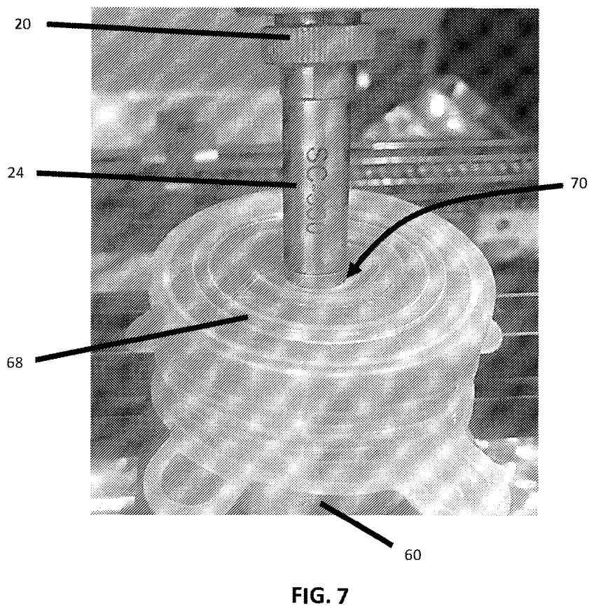

In the cleaning position, the applicator 20 can be disposed in a cleaning apparatus. Referring to FIGS. 3-8, a cleaning apparatus 60 can define a reservoir 64 configured to receive a portion of the applicator 20 therein. The reservoir 64 may be configured to receive and hold a cleaning material 80 as illustrated in FIG. 3. In some aspects, the cleaning apparatus 60 may be a cup, bowl, or another suitable vessel or container configured to receive the cleaning material 80 and the applicator 20. The cleaning material 80 may include a solvent. It will be appreciated that the solvent may be selected to have a chemical composition suitable to dissolve a type of the accumulated portion of the material 50 on the applicator 20. In some aspects, the applicator tip 24 of the applicator 20 may be configured to be removably disposed in the reservoir 64 such that at least a portion of the applicator tip 24 may be submerged in the cleaning material 80. When the applicator 20 is placed into the cleaning apparatus 60 and into contact with the cleaning material 80, the cleaning material 80 can remove the material 50 that has accumulated on the applicator 20, for example, on the applicator tip 24.

The cleaning apparatus 60 may include an actuator 72 configured to agitate the cleaning material 80. Agitation of the cleaning material 80 may cause or otherwise form cavitation bubbles, which can contact the applicator 20 and the accumulated material 50 thereon. Contact of the cavitation bubbles with the applicator 20 and/or the applicator tip 24 can operate to dislodge, remove, and/or disintegrate portions of the accumulated material 50 on the applicator 20. In some aspects, the actuator 72 may include an ultrasonic transducer that is configured to generate ultrasonic waves. The ultrasonic waves can travel through the cleaning material 80 and form the cavitation bubbles as described above. Operation of the actuator 72 can be controlled by an actuator controller 76 that may be operably connected to the actuator 72. The actuator controller 76 may include an ultrasonic generator. The actuator controller 76 may be operably connected to the processor 120 or to another suitable processor connected to, or external to, the coating system 10. In some aspects, the processor 120 may be configured to send a signal to the actuator controller 76 to turn the actuator 72 on, turn the actuator 72 off, operate the actuator 72 at a predetermined on-off pattern, and/or change one or more operational parameters of the actuator 72 (e.g., change intensity, duration, or another suitable parameter of the ultrasound transducer). In certain aspects, electronic feedback (e.g., current feedback and/or phase feedback) may be received from the actuator 72 (e.g., from the ultrasonic transducer). In response to the electronic feedback, operation of the actuator 72 and/or the ultrasonic transducer (e.g., one or more of the operational parameters of the actuator 72) may be adjusted. Such adjusted operation is generally based on the received electronic feedback and may generally be aimed at operating the actuator 72 (e.g., the ultrasonic transducer thereof) at its resonant frequency. This may be achieved by, for example, using phase tracking between the voltage and current signals and adjusting the driver frequency and power to drive the system at resonance.

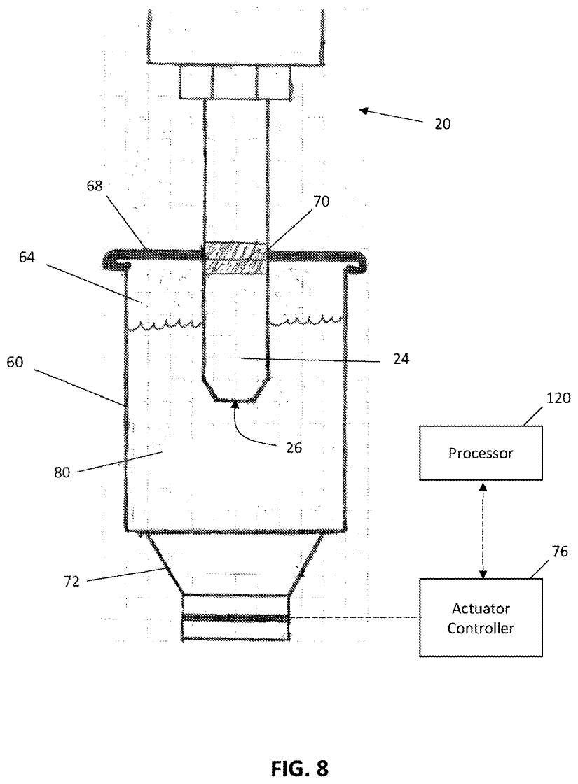

An advantage of such an arrangement is that the formed cavitation bubbles physically contact the adhered material on the applicator 20 and/or the applicator tip 24, thus causing the adhered material to be separated from the applicator 20 (and, specifically, from the applicator tip 24). Additionally, generation of bubbles throughout the cleaning material 80 causes movement of the cleaning material 80 in the cleaning apparatus 60 with respect to the portion of the applicator 20 and/or the applicator tip 24 inserted therein. Such movement allows for better penetration of the cleaning material 80 into and around the accumulated material 50) on the applicator 20, as well as penetration into spaces between the accumulated material 50 and the applicator 20 to better dislodge the accumulated material 50. The generated bubbles thus effectively perform a “scrubbing” operation to physically remove the accumulated material 50 from the applicator 20. However, the contact by the bubbles is generally not abrasive and does not damage the applicator 20 (unlike, for example, utilizing a brush with bristles to scrub material away). Additionally, the movement of the cleaning material 80 caused by the generation of bubbles by the actuator 72 allows for the cleaning material 80 to better enter smaller crevices and openings of the applicator 20 itself during the cleaning process: for example, agitation of the cleaning material 80 by the actuator 72 can allow for better penetration of the cleaning material 80 inside the applicator 20. For example, the cleaning material 80 may enter the applicator tip 24 through an opening 26 of the applicator tip 24, through which the coating material 50 may be discharged during operation of the coating system 10 (see FIG. 8).

The use of ultrasonic waves that travel through the cleaning material 80 as described herein may, in some aspects, cause evaporation of the cleaning material 80. Over a production shift, the fluid level of the cleaning material 80 may therefore decrease below a desirable level. A drop or decrease in the fluid level of the cleaning material 80 may change the optimal frequency for cleaning using ultrasonic waves and/or may cause the fluid level to be below a level at which the portion of the application 20 to be cleaned (e.g., the nozzle) is in contact with the cleaning material 80. In an effort to address the foregoing evaporation of the cleaning material 80, the fluid level of the cleaning material 80 may be measured. The fluid level of the cleaning material 80 may be measured periodically (e.g., at production shift) or continuously and may be measured by any suitable means to suit a desired application. By way of non-limiting example, in an “active” refill system, a fluid level sensor may be employed, with the fluid level sensor configured to measure the fluid level of the cleaning material 80. By way of further non-limiting example, in a “passive” refill system, a gravity-fed reservoir may be employed, with the gravity-fed reservoir configured to add the cleaning material 80. Generally, the cleaning material 80 may be added or refilled such that the fluid level is greater than or equal to a desired level (i.e., a predetermined value). The desired level or predetermined value may generally correspond to a minimum fluid level that does not detrimentally change the optimal frequency for cleaning using ultrasonic waves and/or at which the portion of the application 20 to be cleaned (e.g., the nozzle) is in contact with the cleaning material 80. In order to determine whether cleaning material 80 should be added or refilled, the fluid level of the cleaning material 80 may be monitored or measured as previously described. Thereafter, the measured fluid level of the cleaning material 80 may be compared to the desired level or predetermined value. If it is determined that the fluid level of the cleaning material 80 is less than the desired level or predetermined value, additional cleaning material 80 may be added or refilled to raise the fluid level of the cleaning material 80 to be greater than or equal to the desired level or predetermined value.

In some aspects, when the processor 120 transmits the first signal in response to the comparison process described earlier, the first signal may include an instruction to the actuator controller 76 to turn on the actuator 72 when the applicator 20 has been moved to the cleaning position. The processor 120 may send an instruction to the actuator controller 76 to stop operation of the actuator 72. The instruction to stop the actuator 72 may be part of the second signal described above. The processor 120 may be configured to send the instruction to stop operation of the actuator 72 at a predetermined time. For example, in some aspects, the instruction to stop operation of the actuator 72 may be sent substantially immediately after the processor 120 determines that the measured value/values is/are outside of the acceptable range. In other aspects, the instruction to stop operation of the actuator 72 may be send after a predetermined duration after the processor 120 determines that the measured value/values is/are outside of the acceptable range. This may allow for the clog to dissipate on its own and/or for the user to initiate another procedure.

The duration of operation of the actuator 72 may be predetermined and preprogrammed into the actuator controller 76 and/or the processor 120. If a result of a comparison of values, as described above, results in the applicator 20 being moved to the cleaning position, the processor 120 may be configured to perform a subsequent comparison of values after a set duration of actuation of the actuator 72 or, alternatively, after a set number of actuations of the actuator 72. For example, if a first comparison results in the processor 120 transmitting the first signal and causing the applicator positioning assembly 34 to move the applicator 20 to the cleaning position, the processor 120 can then cause the actuator controller 76 to turn on the actuator 72 for a predetermined duration. After the actuator 72 has operated for the predetermined duration (or for a number of predetermined durations), the processor 120 can send an instruction to the actuator controller 76 to turn off the actuator 72. The processor 120 can then perform a second comparison to determine if the clogging conditions described above are still met or if the clogging conditions have been remediated by the cleaning process of the cleaning apparatus 60 and the actuator 72. If the second comparison results in values within the predetermined ranges, the processor 120 can transmit the second signal, which can include moving the applicator 20 back to the operating position. If the second comparison results in values outside of the predetermined ranges, the processor 120 can transmit the first signal again, which can include sending an instruction to the actuator controller 76 to turn on the actuator 72 again to perform another cleaning process of the applicator 20 and/or the applicator tip 24. The above steps can be repeated until the processor 120 transmits the second signal, indicating no clogging. In some aspects, the above steps can be repeated for a predetermined maximum number of times. If, after the maximum number of times, the processor 120 still does not transmit the second signal, the processor 120 may send an instruction to one or more of the user input/output assemblies 140 to alert the user. At this time, the processor 120 may terminate operation of the coating system 10 until the user initiates operation from one or more of the input/output assemblies 140, for example after manual cleaning and/or replacement of the applicator 20 and/or the applicator tip 24.

To determine if the cleaning described above was effective in removing or reducing the clog, the coating system 10 can flow a material therethrough and measure its variables (e.g., temperature, flow rate, pressure, and the like). This determination can be made when the applicator 20 is in the operating position, in the cleaning position, or in another position. In some aspects, the applicator 20 may be disposed in a purging position when the above determination is being made, with the purging position being different from the operating position and the cleaning position. When the applicator 20 is in the purging position, a purging material may be flowed therethrough to allow the coating system 10 to measure the temperature, pressure, flow rate, viscosity, and/or other variables associated with the flow: The purging material may include the material 50, the cleaning material 80, and/or another suitable flowable material. If, after cleaning, the coating system 10 determines that the clog was not sufficiently removed or reduced, the cleaning steps described above can be repeated. In aspects where the applicator 20 was moved away from the cleaning position to the operating position or to the purging position, the applicator 20 can be moved back to the cleaning position.

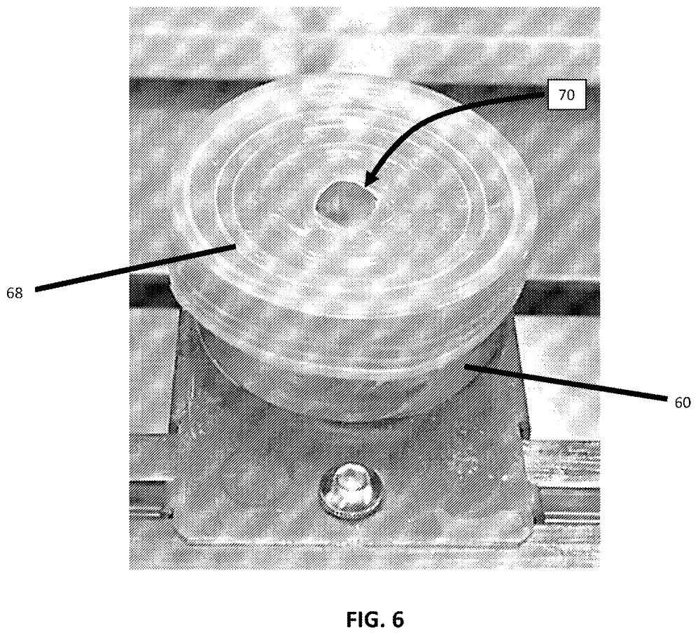

In some aspects, a type of the cleaning material 80 utilized with the cleaning apparatus 60 described above can include solvents that evaporate rapidly. Such evaporation can cause undesirable fumes to be present in or around the coating system 10, which may be hazardous to the users in proximity of the coating system 10. Rapid evaporation of the solvent can require frequent refilling of the cleaning apparatus 60 with additional solvent. As shown in FIGS. 6-8, the cleaning apparatus 60 may include a lid 68 configured to removably attach to the cleaning apparatus 60, such that the lid 68 is configured to enclose at least a portion of the reservoir 64. The lid 68 may include any suitable material, such as silicone. It will be appreciated that the materials of the cleaning apparatus 60 and the lid 68 should be compatible with a type of the cleaning material 80 and the coating material 50 that will be utilized to limit degradation, rusting, and/or other chemical or structural damage to the cleaning apparatus 60 and/or the lid 68 by the cleaning material 80 and/or coating materials 50.

The lid 68 may include an aperture 70 extending therethrough. The aperture 70 should be sufficiently sized to allow the applicator 20 and/or the applicator tip 24 to pass therethrough when the applicator 20 is moved into the cleaning position. In some specific examples, the aperture 70 should be sufficiently sized to allow the applicator tip 24 to pass therethrough. The aperture 70 should also be sufficiently sized such that, when the applicator 20 is disposed therein, the clearance in the aperture 70 between the applicator 20 and the lid 68 is small enough to limit substantial amounts of evaporated solvent in the reservoir 64 from exiting the reservoir 64 though the aperture 70. In some aspects, the lid 68 may include an elastic material configured to deform, and the aperture 70 may be slightly smaller than the applicator 20 (e.g., the applicator tip 24), such when the applicator 20 is inserted into the aperture 70, the applicator 20 deforms the lid 68. In such aspects, the lid 68 may be configured to contact most, or all, of the applicator 20 and/or the applicator tip 24 disposed in the aperture 70, thus limiting evaporated solvent from moving out of the reservoir 64 through the aperture 70 when the applicator 20 is inserted therein.

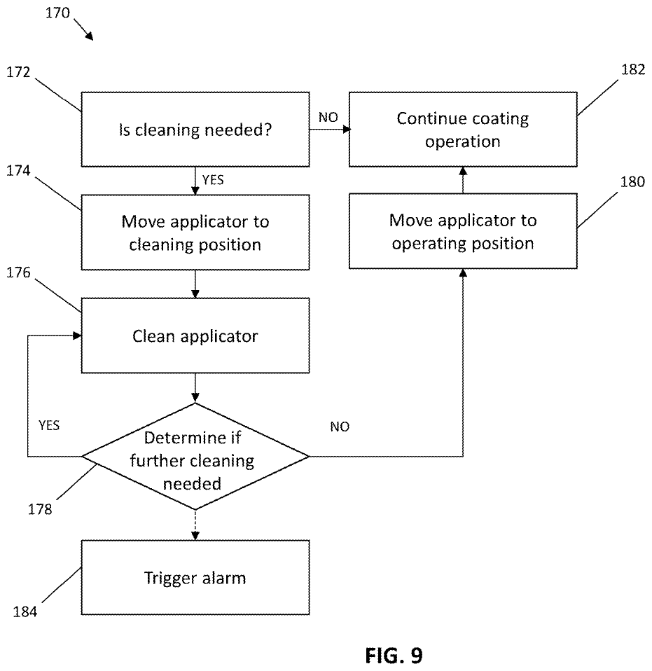

An exemplary cleaning process 170 is depicted in FIG. 9. The process 170 illustrated in FIG. 9 and described below may include any one or more other features, components, arrangements, and/or the like as described herein. It should be noted that the aspects of the process 170 may be performed in a different order consistent with the aspects described herein. Additionally, it should be noted that portions of the process 170 may be performed in a different order consistent with the aspects described herein. Moreover, the process 170 may be modified to have more or fewer processes consistent with the various aspects disclosed herein. In one aspect, the process 170 may be controlled by the processor 120. In one aspect, the process 170 may be implemented by software executed by the processor 120. In an initial step 172, the processor 120 can determine if cleaning is required. The processor 120 may determine if a clog is present, a clog is being formed, and/or if conditions are ripe for a clog to be formed, as described in detail above. If the processor 120 determines that cleaning is required, the processor 120 can transmit the first signal to one or more components of the coating system 10, and if the processor 120 determines that cleaning is not required, the processor 120 can transmit the second signal.

If cleaning is not needed, the process 170 can progress to step 182, in which the operation of the coating system 10 continues per any preset parameters as described herein.

If the processor 120 determines that cleaning is needed, the process 170 may proceed to step 174, in which the applicator 20 can be moved from the operating position to the cleaning position. This can be implemented by actuating the applicator positioning assembly 34 to cause movement of the applicator 20, as described above.

When the applicator 20 is in the cleaning position, the applicator 20 can be cleaned in step 176. The cleaning can include any of the cleaning methods and mechanisms described above. The cleaning step 176 can include placing the applicator 20 (e.g., the applicator tip 24) into the cleaning apparatus 60 such that the cleaning material 80 contacts at least a portion of the applicator 20 (e.g., at the applicator tip 24). The cleaning step 176 can also include sending a signal to the actuator controller 76 to activate the actuator 72, which can include an ultrasonic generator that produces ultrasonic waves through the cleaning material 80, thus agitating the cleaning material 80 and forming cavitation bubbles therein. Step 176 can continue for a predetermined duration and/or for predetermined iterations as previously described.

After the cleaning process has been completed, the process 170 can commence to step 178, where the processor 120 can perform another test to determine if any further cleaning is necessary. The processor 120 can make this determination largely in the same or similar way as in step 172, for example, by comparing different values to determine if a clog is present, formation of a clog has started, and/or conditions are ripe for a clog to form. During step 178, a material may be flown through the applicator 20 to allow measurement of flow-related variables, such as flow rate. The material may include the coating material 50, the cleaning material 80, and/or another suitable material. In some aspects, during step 178, the applicator 20 may be moved from the cleaning position to the operating position, in which the material is flowed through the applicator 20 and the determination of clog presence is made. Alternatively, the applicator 20 may be moved from the cleaning position to the purging position as described above.

If the cleaning in step 176 was successful, the processor 120 may determine that no further cleaning is necessary, and the process 170 can commence to step 180, in which the applicator 20 is moved from the cleaning position to the operating position. Once the applicator 20 is in the operating position, the coating system 10 can commence or resume coating operation is step 182 per predetermined operation parameters. If, during step 178, the applicator 20 was moved to the operating position to determine if further cleaning was needed, then, in step 180), the applicator 20 can remain in the operating position.

If the processor 120 determines, in step 178, that further cleaning is required, the process can repeat step 176 to clean the applicator 20 again. If, in step 178, the applicator 20 was moved away from the cleaning position (e.g., into the operating position or into the purging position), then the applicator 20 can be moved into the cleaning position again per step 174. Steps 178 and 176 (and, if needed, step 174) can be looped for a predetermined number of times until either the processor 120 determines, in step 178, that further cleaning is no longer required, or the number of repeated iterations reaches a predetermined threshold number.

In some aspects, the process 170) can include a step 184, in which, after a predetermined number of iterations of steps 176 and 178 the processor 120 still determines that the applicator 20 requires further cleaning, a signal is sent to the user via human machine interface and/or the input/output assemblies 140. The signal can be an alarm signal and can notify the user of an error condition indicative of a clog that cannot be removed from the applicator 20 or a fault in the processor 120. The alarm can include visual, auditory, tactile, and/or other indications perceptible by the user. Step 184 may also include stopping operation of the process 170 and/or operation of the coating system 10 until the user restarts operation.

In some exemplary aspects, the coating system 10 may be configured to learn, over time, when clogs can become formed. This learning can be based on comparison of measured values and/or control values as described above, on the coating material 50 used, on the substrates 30 being coated, on the parameters of the applicator 20, and/or on other operating parameters of the coating system 10. Such learning can help the coating system 10 to predict when a clog will be formed and to preemptively clean the applicator 20 before such a clogging condition is met. This can help decrease necessary cleaning time and/or associated down time of the coating system 10 while cleaning is occurring. This can also decrease a required number of iterations to sufficiently clean the applicator 20 and/or the applicator tip 24. Preemptive cleaning can also decrease damage to the applicator 20 and/or the applicator tip 24 by abrasive cleaning measures that could otherwise be needed if the formed clog is difficult to remove.

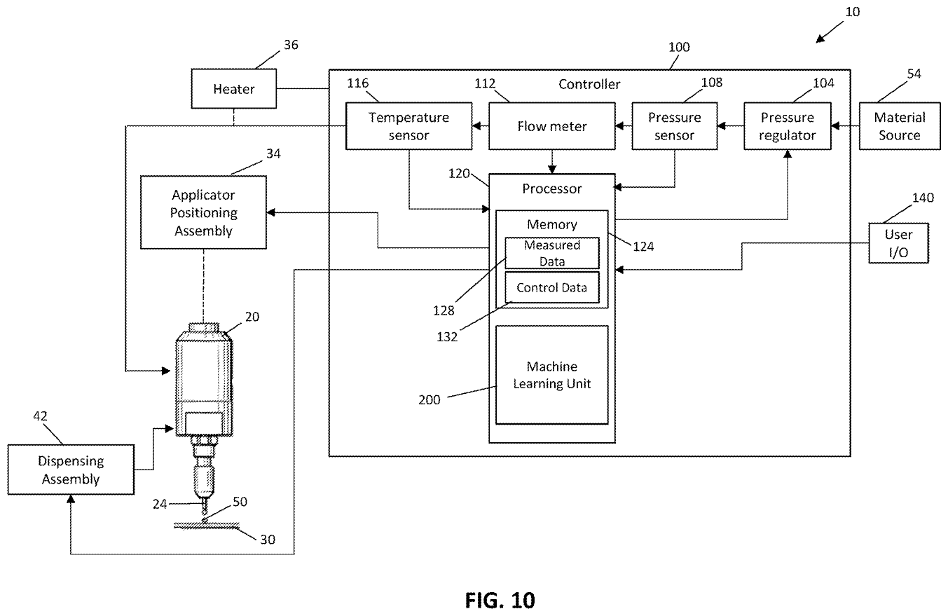

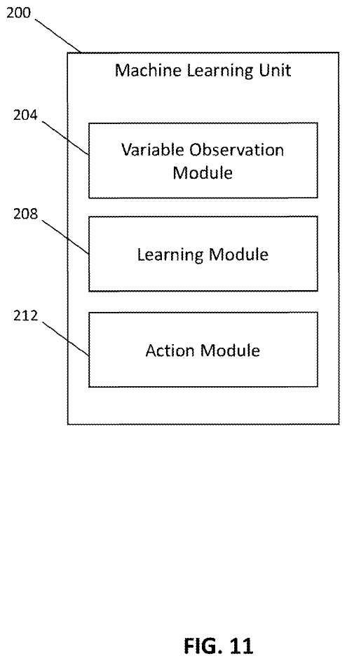

Referring to FIGS. 10-12, the processor 120 of the coating system 10 can include a machine learning unit 200. The coating system 10 illustrated in FIGS. 10-12 can include any one or more of the other features described herein. The machine learning unit 200 can include a variable observation module 204, a learning module 208, an action module 212, and/or the like. The variable observation module 204 may be configured to receive various measured and detected values of the coating system 10 as previously described. The variable observation module 204 can receive any one of the measured pressure values P1, P2, . . . , Pn, the measured flow rate values F1, F2, . . . , Fn, the measured temperature values T1, T2, . . . , Tn, and/or other measured parameters of the coating system 10 that can be stored in the memory 124 of the processor 120. The variable observation module 204 can also receive values pertaining to duration of coating operation of the coating system 10, information pertaining to the coating material 50, such as a type of the material 50, information pertaining to the substrate 30, the number of substrates 30 being coated, and/or any other operating parameters. The variable observation module 204 can also receive indication of when the processor 120 determines that a clog has been formed, a clog is forming, or conditions are ripe for formation of a clog.

The machine learning and/or artificial intelligence may utilize any number of approaches including one or more of cybernetics and brain simulation, symbolic, cognitive simulation, logic-based, anti-logic, knowledge-based, sub-symbolic, embodied intelligence, computational intelligence and soft computing, machine learning and statistics, and the like.

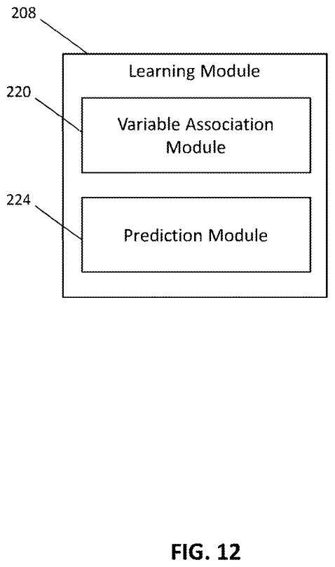

The learning module 208 may be configured to utilize the variables received in the variable observation module 204 to form associations between variables and to form predictive equations to predict when a clog will likely form based on some or all of the above variables. The learning module 208 can include a variable association module 220 as illustrated in FIG. 12, which may be configured to generate associations between and/or among the variables listed above. Various associations may be generated. For example, an association may be formed between the duration of the coating operation, the parameters of the coating material 50, detection of a clog by the processor 120, and/or the like. Another exemplary association can be formed between duration of the coating operation, parameters of the coating material 50, measured flow rate, measured temperature, measured pressure, detection of a clog. It will be appreciated that the above examples are not limiting, and any other suitable associations can be formed based on measured values and/or preprogrammed parameters in the coating system 10.

The learning module 208 may further include a prediction module 224 configured to utilize one or more associations of variables to predict when a clog will likely form or begin to form, or when conditions will be ripe for a clog to form. For example, utilizing an association between duration of the coating operation and the detection of a clogging condition, the prediction module 224 can estimate how long the coating system 10 can operate before a clog will likely be detected. Generally, the prediction module 224 can utilize any of the various variables described above, to determine when, during operation of the coating system 10 according to the variables and combination of variables results in a detected clog. The prediction module 224 can then estimate a future instance of a clogging condition based on the variable associations formed in the variable association module 220. The prediction module 224 can utilize a plurality of variable associations, including associations between different variables, associations between iterations of the same variables, or both.

In some aspects, the prediction module 224 may receive instantaneous operating parameters of an operation of the coating system 10. Those instantaneous operating parameters can be compared to various associations formed in the variable association module 220. If an exact match exists in the variable association module 220, the prediction module 224 can predict a future development of a clogging condition based on the associations in the variable association module 220. If no exact match exists in the variable association module 220, the prediction module 224 can rely on multiple associations that are closest to the received instantaneous operating parameters. The prediction module 224 can then mathematically extrapolate when a future clogging condition can occur based on the received operating parameters and the plurality of associations from the variable association module 220.

The machine learning unit 200 can also include an action module 212 that may be configured to communicate with the processor 120. After a prediction of a future clog is generated in the prediction module 224 of the learning module 208, the action module 212 can communicate an instruction to the processor 120 of an impending clogging condition. The action module 212 can monitor operating parameters of the coating system 10, and, when the parameters reach the prediction formed by the prediction module 224, the action module 212 can initiate a cleaning process, for example, such as the process 170 described previously. In some aspects, the action module 212 can initiate a cleaning process when one or more operating parameters received in the variable observation module 204 are within a predetermined deviation from the prediction generated in the prediction module 224. For example, if the prediction module 224 indicates that a clogging condition is expected to occur after n minutes of coating operation, the action module 212 can communicate to the processor 120 an instruction to initiate the cleaning process at n−5 minutes. This would allow for cleaning the applicator 20 preemptively before the clogging condition has been met. It will be appreciated that, although the above example utilizes operating time, the specific predetermined deviation can be any sufficient deviation, can apply to any of the measured variables (e.g., flow rate, pressure, temperature, operating time, and/or the like), and/or can depend on other operating parameters (e.g., coating material 50, cleaning material 80, substrate 30, number of substrates, operating time, speed of coating operations, size of applicator 20, pattern of coating material 50 discharged from the applicator 20, a type of or configuration of the applicator tip 24 and/or other operating parameters).

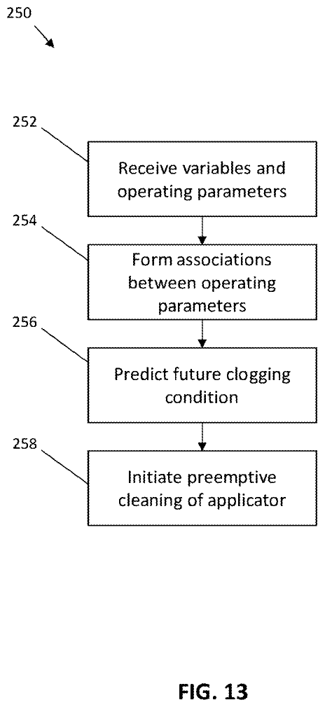

FIG. 13 shows an exemplary process 250 by which the coating system 10 can preemptively clean an applicator 20 before a clogging condition exists. The process 250 illustrated in FIG. 13 and described below may include any one or more other features, components, arrangements, and/or the like as described herein. It should be noted that the aspects of the process 250) may be performed in a different order consistent with the aspects described herein. Additionally, it should be noted that portions of the process 250) may be performed in a different order consistent with the aspects described herein. Moreover, the process 250 may be modified to have more or fewer processes consistent with the various aspects disclosed herein. In one aspect, the process 250) may be controlled by the processor 120. In one aspect, the process 250 may be implemented by software executed by the processor 120. In step 252, the machine learning unit 200 may receive various operating parameters, such as those described above, in the variable observation module 204. The operating parameters can include preset parameters of the coating system 10 (e.g., size of applicator 20, coating material 50) parameters, substrate 30 parameters, quantity of substrates 30, speed of coating, pattern of coating, and/or the like). The operating parameters can also include measurements of values during operation of the coating system 10 (e.g., pressure, flow rate, and/or temperature of coating material 50), duration of operation, time since last cleaning, quantity of substrates 30 coated, quantity of substrates 30 coated since last cleaning, and/or the like). The operating parameters also include detection of a clog, formation of a clog, and/or a condition ripe for formation of a clog (collectively “clogging condition”).

In step 254, the variable association module 220 of the learning module 208 forms associations between the various operating parameters received in step 252. The associations can be between one or more of the preset parameters, one or more of the measured values, and the detected clogging condition. It will be appreciated that the clogging condition can be dependent on any one of the preset parameters and/or measured values or on combinations of multiple preset parameters and/or measured values.

In step 256, the prediction module 224 can utilize the one or more associations generated in step 254 to predict a future clogging condition. The prediction can be based on preset and/or measured values received in the variable observation module 204 and/or on values stored in the memory 124 (e.g., in the measured data 128 and/or the control data 132). The prediction step 256 can include matching received values with those in generated associations and/or utilizing a plurality of associations to extrapolate a predicted future occurrence of a clogging condition. The future prediction can be predicated on one or more measurable conditions, such as time of operation, flow rate, temperature, pressure, material viscosity, and/or the like. For example, the prediction module 224 can predict that a clogging condition will occur after n minutes have passed, when the measured flow rate of the coating material 50 is Fn, when the measured temperature of the coating material 50 is Tn, when the measured pressure of the coating material 50 is Pn, when an n number of substrates 30 have been coated with the coating material 50, and/or the like. It will be appreciated that the prediction can be presented as one or more variables that can be monitored.

In step 258, the action module 212 is configured to receive the prediction generated in step 256. The action module 212 can communicate with the processor 120 to initiate a preemptive cleaning of the applicator 20 based on the generated prediction and on measured operating parameters of the coating system 10. For example, the preemptive cleaning may implement the process 170 as previously described. When one or more operating parameters of the coating system 10 reach the indicated prediction variable, the action module 212 can communicate to the processor 120 that a cleaning process needs to be performed. The processor 120 can initiate such a cleaning process associated with the process 170 as described previously.

It will be appreciated that other steps can be performed in the process 250, and that steps described herein can be performed in different orders relative to each other. One or more steps can be repeated, either consecutively or elsewhere in the process 250.

In addition to or alternatively to the foregoing aspects of cleaning the applicator based upon a comparison between a measured parameter (e.g., flow rate, temperature, pressure) of the material being dispensed via the applicator and a reference value, other parameters or methods may be employed to detect or determine that the applicator should be cleaned. For example, in certain aspects, contamination of the applicator (e.g., of a nozzle thereof), may cause dispensing and/or coating quality problems such as undesirable coverage or placement accuracy, and the measuring of material parameters (e.g., flow rate, temperature, pressure) may not detect such contamination until a clogging condition has occurred. In certain aspects, it may be desirable to detect such contamination prior to such a clogging condition existing.

In certain aspects, a vision system may be employed. The vision system may capable of more readily and quickly detecting the need for cleaning the applicator, even before a clogging condition exists. The vision system may be any suitable vision system as desired to suit a particular application. By way of non-limiting example, the vision system may be an onboard vision system (e.g., positioned onboard the applicator) or may be a downstream vision system (e.g., positioned downstream of the applicator in the coating process). Using the vision system, a visual inspection of the applicator may be performed. Based on the visual inspection of the applicator as discussed herein, dispensing of the material from the applicator (e.g., onto one or more substrates) may be stopped and the applicator may be cleaned as described herein. After cleaning the applicator, dispensing of the material may be resumed.

Generally, the vision system may include one or more cameras. Such camera(s) may be configured to capture one or more images to be used in determining whether the applicator should be cleaned. For example, the camera(s) of the vision system may be configured to capture one or more images of a nozzle through which the material is dispensed, a fluid pattern of the material being dispensed, and/or the substrate(s) on which the material is dispensed.

According to one aspect, a nozzle through which the material is dispensed from the applicator may be visually inspected. For example, the camera(s) may capture one or more images of the nozzle (e.g., during and/or after dispensing of the material). In certain aspects, the camera(s) may capture one or more images of specific portions of the nozzle (e.g., an opening in the nozzle). The captured image(s) may then be processed to generate a first value based on a residual material on the nozzle. The first value may then be compared to a predetermined value. Based on such comparison, it may be determined whether the first value is outside tolerances set for the predetermined value. If the first value is outside tolerances set for the predetermined value, the applicator may be moved from the dispensing or operating position to the cleaning position, as described herein. In the cleaning position, at least some of a residual material may be removed from the applicator. Following removal of at least some of the residual material from the applicator, the applicator may be moved to the dispensing or operating position. In some aspects, additional image(s) of the nozzle may be captured. The additional captured image(s) may then be processed to generate a second value based on the residual material on the nozzle. The second value may then be compared to the predetermined value. Based on such comparison, it may be determined whether the second value is outside tolerances set for the predetermined value. If the second value is outside tolerances set for the predetermined value, the applicator may be further cleaned. Conversely, if the second value is within tolerances set for the predetermined value, dispensing of the material from the applicator may be resumed.

Visual inspection and/or measurement of contamination on and/or within the applicator (e.g., on and/or within the nozzle thereof) may be accomplished by any suitable means for suiting a particular application. By way of non-limiting example, a representative system and method is described in commonly-owned U.S. Pat. No. 10,906,058, the disclosure of which is hereby incorporated by reference herein in its entirety for all purposes.

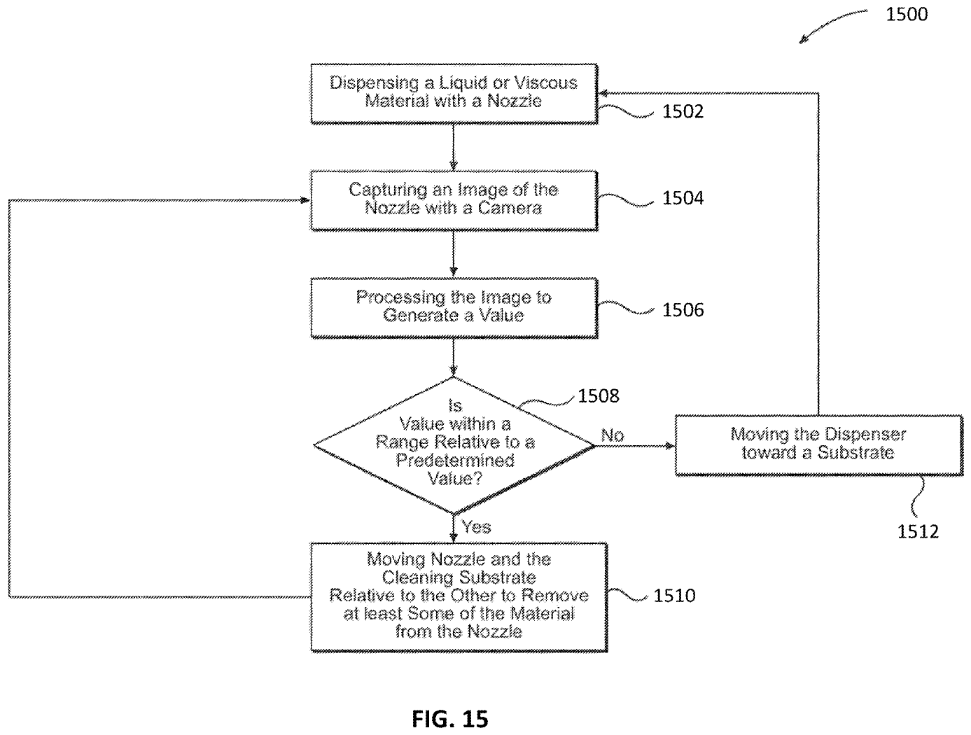

By way of non-limiting example, FIG. 15 illustrates a flow chart depicting a method 1500 of inspecting a dispensing nozzle. Each of the steps of method 1500 may be performed based on one or more signals generated by a controller.

In step 1502, the applicator may dispense a material onto a substrate (e.g., via a nozzle). The controller may perform step 1502 for a predetermined period (e.g., about 1-2 dispensing hours), a predetermined number of cycles, and/or any number of other metrics that estimate the accumulation of material on an external surface of the dispensing nozzle. After the metric has elapsed, the controller may proceed to step 1504 for inspection.

In step 1504, the controller may actuate a camera to capture an image of the dispensing nozzle, such as an opening or valve in the dispensing nozzle. The controller may actuate a positioner to align the dispensing nozzle with an angled mirror. The images may be captured, by the camera, in greyscale to facilitate processing and determining the amount of material accumulated on the dispensing nozzle. Alternatively, the images may be captured by the camera in color and then converted to greyscale to facilitate processing.

In step 1506, the controller may process the image. The controller may capture a predetermined subset of the images depicting the dispensing nozzle, and the subset may be processed to generate a value based on the pixel intensity of the image. In some aspects, the controller may process the captured image by comparing one or more pixels of the captured image to one or more corresponding pixels of an image of a clean dispensing nozzle to determine variations in pixel intensity. The pixel intensity variation may indicate an amount of material coated on the dispensing nozzle because portions of the dispensing nozzle coated by a material would be darker than corresponding clean portions of the dispensing nozzle. The comparison would provide an array of pixel intensity variations. The controller may then normalize the array to generate the value as a scalar quantity indicative of the variation in pixel intensity of the captured image and the amount of material accumulated on the dispensing nozzle.

An image of a dispensing nozzle that is clean (e.g., lacking material accumulation) may be processed by the controller to generate, for example, a high value (e.g., 80-90 on a scale of 0 to 100) to indicate that the nozzle is comparable to an image of a clean dispensing nozzle: therefore, the dispensing nozzle may continue to dispense without cleaning. An image of a dispensing nozzle after a few dispensing cycles (e.g., with minimal accumulation of material on the surface the dispensing nozzle, but not sufficient to reduce dispensing efficiency) may be processed with the controller to generate a relatively high value (e.g., 60-70 on a scale of 0) to 100). On the other hand, an image of a dispensing nozzle having substantial material accumulation on the surface (e.g. where the accumulation of material may block the opening of the dispensing nozzle and reduce the quality of dispensing to an unacceptable level) may be processed, and based on such processing, the controller may detect the material accumulation when processing the image and generate, for example, a relatively low value (e.g., 9-18 on a scale of 0 to 100).

In step 1508 the controller may determine if the value is within a range relative to a predetermined value indicating the dispensing nozzle being sufficiently clean. For example, the predetermined value may be a predetermined percentage (e.g., 50%) of a clean nozzle, and step 1508 may determine if the value is within the range indicating the nozzle is clean. If the value is determined not to be in the range indicating the nozzle being sufficiently clean (“NO”), the controller may proceed to step 1510. If the value is determined to be in the range (“YES”), the controller may proceed to step 1512.

In step 1510, the controller may move the applicator (e.g., the dispensing nozzle thereof) from the dispensing or operating position to the cleaning position, as described herein, to remove at least some of the residual material from the dispensing nozzle, as further discussed herein. After cleaning the dispensing nozzle in step 1512, the controller may return to step 1504, where the camera(s) captures an additional image(s) of the dispensing nozzle. Additional cleaning may be required to make the dispensing nozzle sufficiently clean for dispensing in step 1502.

In step 1512, the controller may move the applicator (e.g., the dispensing nozzle thereof) to the dispensing or operating position. The controller may then proceed to step 1602, where the dispensing nozzle dispenses the material onto the substrate.

According to another aspect, the fluid pattern of the material being dispensed from the applicator may be visually inspected. For example, the camera(s) may capture one or more images of the fluid pattern as the material is being dispensed. The captured image(s) may then be processed to generate actual fluid pattern information of the fluid pattern. The actual fluid pattern information may then be compared to fluid pattern information for the fluid pattern. Based on such comparison, it may be determined whether the actual fluid pattern is outside tolerances set for the fluid pattern. If the actual fluid pattern is outside tolerances set for the fluid pattern, the applicator may be moved from the dispensing or operating position to the cleaning position, as described herein. In the cleaning position, at least some of a residual material may be removed from the applicator.

Visual inspection and/or measurement of the fluid pattern of the material being dispensed from the applicator may be accomplished by any suitable means for suiting a particular application. By way of non-limiting example, a representative system and method is described in commonly-owned U.S. Pat. No. 10,758,926, the disclosure of which is hereby incorporated by reference herein in its entirety for all purposes.

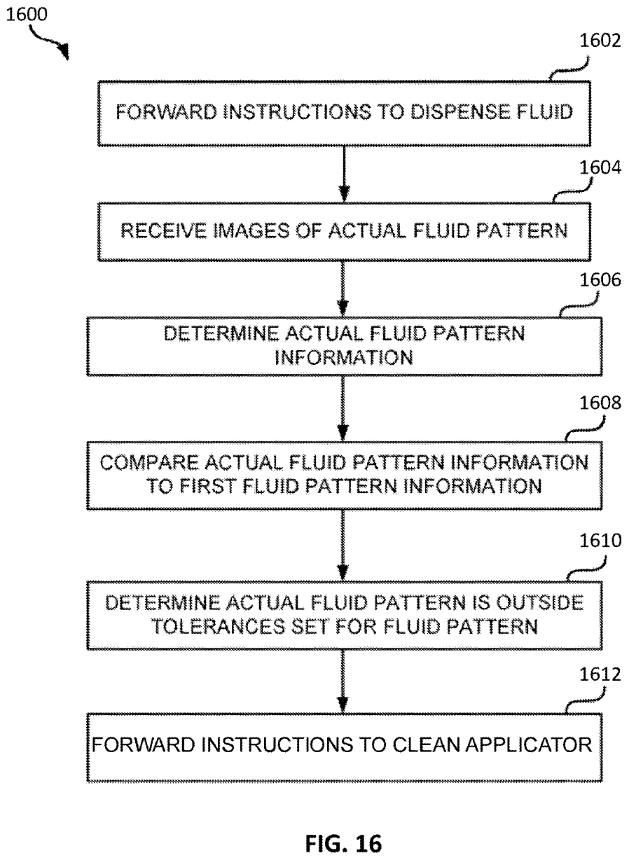

By way of non-limiting example, FIG. 16 a flow chart depicting a process 1600 of inspecting a fluid pattern. The process 1600 may be executed by a controller. The process 1600 starts at step 1602. In step 1602, the controller may forward instructions to the applicator and/or the dispensing nozzle to dispense the material or fluid according to one or more system parameters that are intended to produce a fluid pattern. The one or more system parameters may include any parameter relating to the operation of the fluid dispensing system, such as a fluid pressure, velocity, and/or volume of the fluid provided to the dispensing nozzle, the horizontal and/or vertical position of the dispensing nozzle, the rotational orientation of the dispensing nozzle, and the pulse timing and/or pulse duration of fluid dispensed from the dispensing nozzle. The one or more system parameters may further include a direction (e.g., horizontal direction) and/or velocity (e.g., horizontal velocity) of movement of the dispensing nozzle relative to the substrate or vice versa. The dispensing nozzle may then dispense the fluid according to the one or more system parameters. The stream or spray dispensed by the dispensing nozzle may have an actual fluid pattern, which may or may not match the intended fluid pattern. In some aspects, the controller may forward instructions as a result of an operator input.

At step 1604, an image(s) of the stream or spray of the fluid showing the fluid pattern are received by the controller from a camera(s). In some aspects, the camera(s) may be continuously capturing and forwarding images of the actual fluid pattern at predetermined time intervals. For example, the controller may receive a video stream of the actual fluid pattern. In other aspects, the controller may forward instructions to the camera(s) to capture images of the stream or spray of the fluid at a particular point(s) in time.

In yet other aspects, the camera(s) may capture one or more images or video streams of the actual fluid pattern from multiple angles. For example, a first camera may capture one or more images or a video stream of the actual fluid pattern from a first angle and a second camera may capture one or more images or a video stream of the actual fluid pattern from a second, different angle. The first angle may be perpendicular to the second angle. As another example, the camera(s) 112 be configured to move between one or more positions relative to the actual fluid pattern (e.g., rotate partially or fully around the actual fluid pattern) and thereby capture one or more images or a video stream of the actual fluid pattern from multiple angles. The one or more images or video streams depicting the actual fluid pattern from multiple angles may subsequently be provided to and received by the controller.

At step 1606, the controller may determine actual fluid pattern information of the actual fluid pattern. The controller may determine the actual fluid pattern information based on the image(s) received from the camera. The actual fluid pattern information may include at least one of a dimension (e.g., a width) of the actual fluid pattern, a shape of the actual fluid pattern, a horizontal or vertical offset of the actual fluid pattern, a density of the actual fluid pattern, a quality of the actual fluid pattern, a size of droplets of the actual fluid pattern, a rotational orientation of the actual fluid pattern, or other characteristic of the actual fluid pattern. An offset of the actual fluid pattern may refer to an offset in position of the actual fluid pattern from a desired alignment. For example, the actual fluid pattern may be centered 2 mm away from a desired location. The controller may determine the actual fluid pattern information based on various image processing algorithms, such as high-pass filtering to determine edges of the actual fluid pattern.

In some aspects, the controller may determine a three-dimensional model of the actual fluid pattern based on image(s) or video stream(s) of the actual fluid pattern received from the camera(s). The three-dimensional model may be created, for example, using known techniques to recognize boundaries and/or features in each of the images of the actual fluid pattern and triangulating (and/or using other tomographic methods) the recognized boundaries and/or features to create a representation of the actual fluid pattern within the model. As the three-dimensional model provides a representation of the actual fluid pattern, the aforementioned actual fluid pattern information may be determined based on the three-dimensional model.

At step 1608, the controller may compare the actual fluid pattern information to fluid pattern information for the intended fluid pattern that corresponds to the one or more system parameters. That is, the observed actual fluid pattern information may be compared to the fluid pattern information that is expected using the one or more system parameters. The fluid pattern information may be the same type of information described above with respect to the actual fluid pattern information except as related to the intended fluid pattern. For example, if the actual fluid pattern information represents a width of the actual fluid pattern, the width of the actual fluid pattern may be compared to the desired width of the intended fluid pattern represented in the fluid pattern information. In some aspects, the controller may calculate a difference between a magnitude of the actual fluid pattern information and the fluid pattern information. In other aspects, the controller may calculate a ratio between the actual fluid pattern information and the fluid pattern information.

At step 1610, the controller may determine, based on the comparison of the actual fluid pattern information to the fluid pattern information, that the actual fluid pattern is outside tolerances set for the fluid pattern. The tolerances set for the fluid pattern may include at least one of a desired width of the fluid pattern, a desired shape of the fluid pattern, a permissible offset of the fluid pattern, a desired density of the fluid pattern, a desired quality of the fluid pattern, a desired size of droplets of the fluid pattern, a desired rotational orientation of the fluid pattern, or other design or process limit for the fluid pattern. For example, the controller may determine that the width of the actual fluid pattern at a particular height is greater than a tolerance of the fluid pattern. In another example, the controller may determine that the sphericity of the droplets in the actual fluid pattern is lower than a tolerance of the fluid pattern. The actual fluid pattern information being outside a tolerance of the fluid pattern may indicate that the applicator (e.g., the dispensing nozzle thereof) needs to be cleaned. Based on the actual fluid pattern information and the fluid pattern information, the controller may determine instructions to clean the applicator (e.g., the dispensing nozzle thereof), as described herein.

At step 1612, the controller may forward instructions to the spray system and/or dispensing nozzle that the same should be cleaned to improve dispensing performance, as described herein.

In some aspects, the controller may forward an alert to an operator of the fluid dispensing system. The alert may indicate the actual fluid pattern is outside tolerances set for the fluid pattern. The alert may indicate that the applicator (e.g., the dispensing nozzle thereof) should be cleaned, as described herein.

According to another aspect, the substrate on which the material is dispensed may be visually inspected. For example, the camera(s) may capture one or more images of the substrate during and/or after dispensing of the material thereon. The captured image(s) may then be processed to generate a first value based on dispensed material on the substrate (e.g., representative of placement of and/or quantity of dispensed material on the substrate). The first value may then be compared to a predetermined value. Based on such comparison, it may be determined whether the first value is outside tolerances set for the predetermined value. If the first value is outside tolerances set for the predetermined value, the applicator may be moved from the dispensing or operating position to the cleaning position, as described herein. In the cleaning position, at least some of a residual material may be removed from the applicator. Following removal of at least some of the residual material from the applicator, the applicator may be moved to the dispensing or operating position. In some aspects, additional image(s) of the nozzle may be captured. The additional captured image(s) may then be processed to generate a second value based on dispensed material on the substrate. The second value may then be compared to the predetermined value. Based on such comparison, it may be determined whether the second value is outside tolerances set for the predetermined value. If the second value is outside tolerances set for the predetermined value, the applicator may be further cleaned. Conversely, if the second value is within tolerances set for the predetermined value, dispensing of the material from the applicator may be resumed.

Visual inspection of the substrate may be accomplished by any suitable means for suiting a particular application. By way of non-limiting example, such visual inspection may be accomplished by employing automated optical inspection (AOI) systems and/or software commercially available from Nordson Corporation of Westlake, Ohio.

While systems and methods have been described in connection with the various embodiments of the various figures, it will be appreciated by those skilled in the art that changes could be made to the embodiments without departing from the broad inventive concept thereof. It is understood, therefore, that this disclosure is not limited to the particular embodiments disclosed, and it is intended to cover modifications within the spirit and scope of the present disclosure as defined by the claims.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto another element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over another element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

1. A method of applying a material to a substrate with a coating system, the method comprising:
dispensing the material onto a substrate using an applicator, the applicator being configured to receive the material therein and to discharge the material therefrom toward the substrate;
measuring a parameter of the material being dispensed via the applicator with a sensor;
comparing the measured parameter to a predetermined range;
based on the comparison of the measured parameter to the predetermined range, stopping the dispensing of the material onto the substrate and cleaning the applicator such that the parameter is within the predetermined range; and
after cleaning the applicator, resuming dispensing the material.

2. The method of claim 1, wherein measuring the parameter of the material includes measuring at least one of a flow rate of the material, a temperature of the material, and a pressure of the material.

3. The method of claim 1, wherein measuring the parameter includes measuring a first parameter and measuring a second parameter,
wherein the method further comprises comparing the measured first parameter with the measured second parameter, and
wherein determining whether the parameter is within the predetermined range includes determining whether the second measured parameter is within a predetermined range compared to the first parameter.

4. The method of claim 1, wherein the applicator is in an operating position when the dispensing step is performed, and the method further comprising moving the applicator to a cleaning position when the parameter is not within the predetermined range.

5. The method of claim 1, wherein the step of cleaning the applicator includes contacting the applicator with a cleaning material for a predetermined duration.

6. The method of claim 5, wherein the cleaning material comprises a solvent.

7. The method of claim 5, further comprising actuating an ultrasonic transducer to agitate the cleaning material to form cavitation bubbles in the cleaning material.

8. The method of claim 7, further comprising receiving electronic feedback from the ultrasonic transducer and adjusting operation of the ultrasonic transducer based on the received electronic feedback.

9. The method of claim 8, wherein the electronic feedback includes at least one of current feedback and phase feedback.

10. The method of claim 8, wherein adjusting operation of the ultrasonic transducer based on the received electronic feedback includes operating the ultrasonic transducer at its resonant frequency.

11. The method of claim 5, further comprising:
measuring a fluid level of the cleaning material;
comparing the measured fluid level to a predetermined value;
in response to a determination that the measured fluid level is less than the predetermined value, adding cleaning material to raise the fluid level of the cleaning material to be greater than or equal to the predetermined value.

12. The method of claim 1, wherein the predetermined range is a predetermined range of values defined between a lower threshold value and an upper threshold value.

13. The method of claim 1, wherein the step of stopping the dispensing includes instructing the coating system to stop the dispensing immediately after completion of the comparison step.

14. The method of claim 1, wherein the step of stopping the dispensing includes instructing the coating system to stop dispensing after a predetermined amount of time has passed after completion of the comparison step.

15. A method of predicting future formation of a clog in a coating system having a dispensing applicator, the dispensing applicator being configured to dispense a material onto a substrate, the method comprising:
measuring a first parameter of the material in the dispensing applicator at a first instance with at least one sensor;
identifying presence of a first clogging condition with a controller;
generating an association between the first parameter and the first clogging condition with the controller;
measuring the first parameter of the material at a second instance after the first instance with the sensor; and
using the measured first parameter at the second instance and the generated association, predicting a future occurrence of a second clogging condition with the controller.

16. The method of claim 15, wherein the step of predicting the future occurrence of the second clogging condition includes using a predetermined control value for the first parameter.

17. The method of claim 16, wherein the predetermined control value includes a control range of predetermined values.

18. The method of claim 15, further comprising notifying a user of the predicted future occurrence of the second clogging condition.

19. The method of claim 15, further comprising activating a cleaning process prior to occurrence of the predicted future occurrence of the second clogging condition, wherein the cleaning process includes removing an accumulated material from the dispensing applicator.

20. The method of claim 15, wherein the first parameter includes at least one of an operation parameter of the coating system and a coating material parameter, wherein the operating parameter of the coating system includes at least one of size of the dispensing applicator, an identifier of the material, and an identifier of the substrate, and wherein the coating material parameter includes at least one of coating material pressure, coating material flow rate, coating material temperature, duration of coating operation, elapsed time since a previous applicator cleaning, quantity of substrates being coated, and quantity of substrates coated since the previous applicator cleaning.

21. The method of claim 20, comprising forming an association between the elapsed time since the previous applicator cleaning and the first clogging condition.

22. The method of claim 21, further comprising generating a plurality of associations, and wherein a future occurrence of the second clogging condition includes identifying a portion of the plurality of generated associations and utilizing portion of the plurality of generated associations to extrapolate a predicted association between the first parameter and a future second clogging condition.

23.-94. (canceled)
